(19) United States
(12) Patent Application Publication
(10) Pub. No.: US 2026/0368535 A1
(43) Pub. Date: Nov. 19, 2026

(54) DWELL TIME OPTIMIZATION SYSTEM

(71) Applicant: Microsoft Technology Licensing, LLC, Redmond, WA (US)

(72) Inventors: Arpita Vats, San Jose, CA (US); Ghulam Ahmed Ansari, Fremont, CA (US); Mohit Rajkumar Kothari, Campbell, CA (US); Fengyu Zhang, Mountain View, CA (US)

(73) Assignee: Microsoft Technology Licensing, LLC, Redmond, WA (US)

(21) Appl. No.: 19/211,705

(22) Filed: May 19, 2025

(51) Int. Cl. G06N 3/09; G06F 16/738; G06N 3/045

(52) U.S. Cl. CPC G06N 3/09; G06F 16/738; G06N 3/045

(57) ABSTRACT

A dwell time optimization system is described. A method includes training a deep neural network (DNN) of a machine learning (ML) model to generate a predicted long dwell metric using a training sample from a training dataset, the training sample comprising a set of features and a target label, the set of features comprising video features associated with a video and entity features associated with an entity identifier (ID), the video features including a video length, and the target label comprising a binary value for a long dwell metric, wherein the binary value is set to a first binary value when a dwell time for the video is greater than or equal to an adaptive threshold value and a second binary value when the dwell time for the video is less than the adaptive threshold value. Other embodiments are described and claimed.

### BACKGROUND

A connection network system uses ranking and recommendation sub-systems. These sub-systems are part of an algorithmic framework that personalizes and prioritizes content, connections, or interactions to enhance user engagement. A ranking sub-system determines the order of content (e.g., posts, ads, jobs) in feeds or search results by assigning relevance scores based on user interactions (e.g., likes, shares), content features (e.g., type, recency), user profiles (e.g., interests, demographics), and context (e.g., time, location). These sub-systems often use machine learning models or rule-based software to ensure the most engaging content appears first. For example, a graphical user interface (GUI) includes a feed section to display ranked content for a user based on the user's past behavior and trending topics, optimizing for real-time relevance and engagement. A recommendation sub-system, on the other hand, provides suggestions to a user such as new content to view, accounts to follow, or groups to join, using techniques like collaborative filtering (based on similar users' preferences), content-based filtering (matching content to user interests), or hybrid approaches. These sub-systems leverage embedding models, graph-based algorithms, and exploration-exploitation strategies to balance familiar and novel content. Technical challenges include avoiding bias, ensuring scalability, protecting privacy, addressing cold-start problems for new users, and a host of other technical problems. Therefore, there is a significant and timely need for improvements of ranking and recommendation sub-systems for a connection network system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates a multi-objective optimization (MOO) framework in accordance with one embodiment.

FIG. 3 illustrates a tower architecture of a machine learning (ML) model in accordance with one embodiment.

FIG. 4 illustrates a training system in accordance with one embodiment.

FIG. 5 illustrates a logic diagram in accordance with one embodiment.

FIG. 6 illustrates a logic diagram in accordance with one embodiment.

FIG. 7 illustrates a logic flow in accordance with one embodiment.

FIG. 8 illustrates an inferencing system in accordance with one embodiment.

FIG. 9 illustrates a logic flow in accordance with one embodiment.

FIG. 10 illustrates a connection network system in accordance with one embodiment.

FIG. 11 illustrates a computing architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. For example, embodiments of the present disclosure comprise a feed service implementing various ML models to generate metrics representing various types of user engagement with content items. The feed service uses the metrics to select content items for presentation on a content feed of a graphical user interface (GUI) of a client device associated with a user for engagement by the user.

Some embodiments implement a dwell time optimization system to assist an ML model in generating the metrics for the feed service. In particular, some embodiments provide an auto-normalized long dwell ML model for modeling “long dwell” behavior that provides significant effectiveness in driving user retention and possesses the capability to adapt automatically as the ecosystem evolves. For example, a binary classifier predicts whether a user will allocate more time to a content item, particularly a video, compared to a specific percentage (x %) of video or member counterparts using a dynamic adaptive threshold. The dynamic adaptive threshold is based, at least in part, on video lengths, video buckets for video lengths, a video distribution, and/or quantiles from a quantile generation pipeline. The ML model implements normalization techniques to address bias and noise in dwell time data. By identifying the top-K attributes that significantly influence dwell time, such as content type, creator type, and distribution method, the model calculates the percentile (e.g., 90%) of long dwell time for each unique combination. This normalization assists in identifying quality content within these attribute categories for a given user. In some embodiments, the adaptive threshold is dynamic and inferred from real world data. This entire process is performed on a periodic, aperiodic or on-demand basis, ensuring that the percentiles remain dynamic rather than static. This adaptability enables the ML model to evolve alongside the ecosystem, accommodating changes in user behavior and shifts in content distributions. The output score of the classifier is integrated into the score utility, incorporating an adjustable weight which is used to control the importance of passive consumption utility in ranking.

Although exemplary embodiments are described in connection with a particular AI system or an ML model, the principles described herein can also be applied to other types of AI systems and ML models as well. Embodiments are not limited in this context.

### Overview

In an online system, such as a connection network system, a content feed is central to member (or user) experience, providing a space for sharing knowledge, ideas, career updates and job opportunities through different media types such as posts, articles, images, or videos. As members come across content items in their content feed that they are curious or interested in, they have multiple ways to engage with that content. They may take explicit actions by commenting on or resharing posts. They might also choose to passively consume the content by reading or viewing it (e.g., dwelling).

To make those different types of engagements possible requires relevance systems that underpin the content feed and are tasked with matching the right content with the right set of content consumers. For example, a feed ranking sub-system attempts to understand member's interests, goals and preferences to provide the most relevant content and conversations. For example, dwell time is a measure of time a member spends on a given content item. Dwell time improves feed ranking by predicting when members will have a short dwell time on a feed post and leveraging that prediction as a negative signal for ranking. Feed ranking systems may treat passive consumption as a positive signal to learn from and optimize. Passive consumption models attempt to capture member preferences and improve their feed experience. These models tend to deliver more quality content to individual members while limiting “click bait” or “dwell bait” content that detracts from the member experience.

A feed ranking sub-system implements a two-pass funnel architecture, which generates candidates in the first pass and ranks them together in the second. A first pass ranker is responsible for retrieving content from a member's network (e.g. posts, news, career updates, etc.) from thousands of potential candidates and relevant out-of-network (OON) recommendations. The first pass ranker maximizes for recall, supplying a large set of potential updates to show members. A second pass ranker gathers updates from different first pass systems and ranks the accumulated results for precision. The second pass ranker leverages a multi-objective, multi-task framework for combining predictive likelihoods from different models into a single combined score for ranking. The final output from this second pass ranker is a ranked list of the most relevant and valuable content for a given member.

A multi-objective optimization (MOO) framework attempts to balance three aspects of the content ecosystem: (1) member side optimization from members' knowledge value from content; (2) downstream optimization impact from member's actions to their network; and (3) creator side feedback optimization which provides upstream value to the creator for different actions taken by the member. With respect to viewer side optimization, this includes passive optimization for passive behaviors (e.g., clicks, dwell time, etc.) and active optimization for active contribution behaviors (e.g., comments, reshares, etc.). A member side optimization model tries to maximize both passive and active optimization via deep neural networks (DNN). It uses a MOO function for balancing the multiple engagement signals that the models learn and optimize, as shown in Equation (1).

[symbol]

Here alpha, beta, gamma and W are all MOO hyper-parameters that are finely tuned to balance tradeoffs and returns from each aspect of the content ecosystem with the goal of maximizing not only the overall user engagement and retention, but also personalization on a member level.

Dwell time is an important signal for a MOO framework. Dwell time refers to the duration users spend on content or posts. Unlike explicit signals such as likes, comments, and shares, dwell time signals are more abundant and offer broader coverage, capturing the engagement of users who passively consume content. This makes dwell time a critical indicator of not only content quality but also relevance, especially for members who enjoy reading content but may not frequently engage explicitly. For instance, many active users are passive consumers who spend time on the feed without taking any explicit actions. This group of users engages with content by reading and viewing without reacting, highlighting the importance of dwell time as their primary engagement signal. Additionally, dwell time is crucial for evaluating the relevance and engagement of out-of-network content, where interactions are less common. For specific content types, such as videos, dwell time becomes even more significant, as users might spend considerable time watching without necessarily liking, commenting, or sharing. This makes dwell time an important metric for understanding how well different types of content resonate with members.

Dwell time is a positive feedback signal for a MOO function. Therefore, an ML model may use dwell time to predict “long dwell” behavior, where a member spends significant time positively engaging with a post. However, creating this type of model involves several technical challenges. For example, using a universal long dwell threshold to build binary classifiers or predicting total dwell time spent on the update is inadequate. Some of the challenges from this method include noisy dwell time signals per update, lack of an adaptive threshold, and an introduction of biases through static thresholds.

A first technical challenge is the presence of noisy dwell time signals per update. For example, dwell time signals are inherently noisy. Dwell time is noisy because of various confounding factors, such as ambiguity of intent (e.g., a long dwell time does not always mean high engagement), contextual variability (e.g., content length, user behavior, platform design), a lack of granularity (e.g., how the user interacted with content), susceptibility to manipulation (e.g., clickbait thumbnails, misleading introductions), completion rate (e.g., high completion rates on short videos for convenience not quality), and other metrics. Directly predicting the dwell time value or logarithm of dwell time proves unsuitable due to excessive volatility and lack of bounds. Outliers with extremely high values are often present in the data. Similar patterns are observed across various content types and feed positions.

A second technical challenge is a lack of adaptive threshold. For example, utilizing a universal, static threshold for determining “long dwell” does not effectively capture user preferences relative to inherent dwell time baselines. Manual determination of such a threshold by humans is subjective, lacking systematic consistency and varying from person to person. For instance, a dwell time of 30 seconds could be considered “long” for an image but not for a video. Moreover, it fails to adapt to changes in dwell time distribution over time, where users spend increasingly more time on certain content types over time. Shifts in user behavior occur over time, favoring certain content types over the other within users' networks. In this case, the static universal threshold is unable to adjust to frequent changes within the ecosystem. For example, shifts in content types displayed or the introduction of a new user interface could significantly impact user interactions, rendering the previously chosen static threshold detrimental to ranking algorithms.

A third technical challenge is an introduction of biases through static thresholds. For example, employing a fixed static threshold introduces biases in the modeling process. The model might learn to prioritize update types with longer dwell times, such as long videos, over short articles. Test results indicate a bias introduced by the fixed threshold, as certain content types may rarely exceed a given duration, while others surpass it more easily. Therefore, a goal is to develop a model that promotes engaging posts across all content types rather than favoring a few specific ones.

Addressing these challenges requires the formulation of novel approaches to overcome noise in dwell time signals, develop adaptive thresholds, and avoid biases in the promotion of content types. To this end, embodiments provide an auto-normalized long dwell model for modeling “long dwell” behavior that provides significant effectiveness in driving user retention and possesses the capability to adapt automatically as the ecosystem evolves. For example, a binary classifier predicts whether a user will allocate more time to a post compared to a specific percentage (x %) of its counterparts using an adaptive threshold. The model implements normalization techniques to address bias and noise in dwell time data. By identifying the top-K attributes that significantly influence dwell time, such as content type, creator type, and distribution method, the model calculates the percentile (e.g., 50%) of dwell time for each unique combination. This normalization prevents a recommendation model from over-recommending based on these specific attributes, and focuses instead on finding quality content within these attribute categories. The system can be extended to any combination of the categorical features unique to a given online system, such as industry of creator, intent of a post, and so forth.

The adaptive threshold is dynamic and inferred from real world data. This entire process is performed on a periodic or a-periodic basis, ensuring that the percentiles remain dynamic rather than static. This adaptability enables the model to evolve alongside the ecosystem, accommodating changes in user behavior and shifts in content distributions. The output score of the classifier is integrated into the score utility, incorporating an adjustable weight which is used to control the importance of passive consumption utility in ranking.

In some embodiments, a training system trains an ML model by incorporating various video features, such as dwell time and video length. The trained ML model predicts a long dwell metric for objects, such as a video object. For example, the training system includes operations for training a deep neural network (DNN) of a ML model over a set of training iterations. A training iteration comprises operations for retrieving a training sample from a training dataset, the training sample comprising a set of features and a target label. The set of features comprise video features associated with a video and entity features associated with an entity identifier (ID). The video features include a video length. The target label comprises a long dwell metric, wherein the binary value is set to a first binary value when a dwell time for the video is greater than or equal to an adaptive threshold value and a second binary value when the dwell time for the video is less than the adaptive threshold value. The DNN generates a predicted long dwell metric from the set of features. The training system computes a loss value between the predicted long dwell metric and the long dwell metric using a loss function. The training system adjusts a set of model parameters (e.g., weights and biases) for the DNN based on the loss value using an optimization function. This process is repeated for the set of training iterations until the ML model is sufficiently trained for deployment in an online system. The trained ML model provides inferencing operations in support of ranking and recommendation sub-systems of the online system. For example, the ranking sub-system uses the ML model to identify and rank content items relevant to a member for presentation on a content feed of a GUI. The recommendation sub-system uses the ML model to identify and recommend content items, connections, or groups relevant to a member on a content feed or another section of the GUI.

Embodiments provide several technical solutions to multiple technical problems. For example, dwell time is a positive feedback signal for a MOO function. Therefore, an ML model may use dwell time to predict “long dwell” behavior, where a member spends significant time positively engaging with a post. However, creating this type of model involves several technical challenges. For example, using a universal long dwell threshold to build binary classifiers or predicting total dwell time spent on the update prove inadequate. Some of the challenges of using this method include noisy dwell time signals per update, lack of an adaptive threshold, and an introduction of biases through static thresholds. Embodiments implement a MOO framework that attempts to balance three aspects of the content ecosystem: (1) viewer side optimization from viewers' knowledge value from content; (2) downstream optimization impact from viewer's actions to their network; and (3) creator side feedback optimization which provides upstream value to the creator for different actions taken by the viewer. With respect to viewer side optimization, this includes passive optimization for passive behaviors (e.g. clicks, dwell time, etc.) and active optimization for active contribution behaviors (e.g., comments, reshares, etc.). A viewer side optimization model tries to maximize both passive and active optimization via deep neural networks (DNN). It uses a MOO function for balancing the multiple engagement signals that the models learn and optimize. Some embodiments in particular provide an auto-normalized long dwell ML model for modeling “long dwell” behavior that provides significant effectiveness in driving user retention and possesses the capability to adapt automatically as the ecosystem evolves. For example, a binary classifier predicts whether a user will allocate more time to a content item, particularly a video, compared to a specific percentage (x %) of its counterparts (e.g., similar content or other members) using an adaptive threshold. The ML model implements normalization techniques to address bias and noise in dwell time data. By identifying the top-K attributes that significantly influence dwell time, such as content type, creator type, and distribution method, the model calculates the percentile (e.g., 50%) of dwell time for each unique combination. This normalization assists in identifying quality content within these attribute categories for a given user. In some embodiments, the adaptive threshold is dynamic and inferred from real world data. This entire process is performed on a periodic, aperiodic or on-demand basis, ensuring that the percentiles remain dynamic rather than static. This adaptability enables the ML model to evolve alongside the ecosystem, accommodating changes in user behavior and shifts in content distributions. The output score of the classifier is integrated into the score utility, incorporating an adjustable weight which is used to control the importance of passive consumption utility in ranking. Other technical advantages exist as well.

### DETAILED EMBODIMENTS

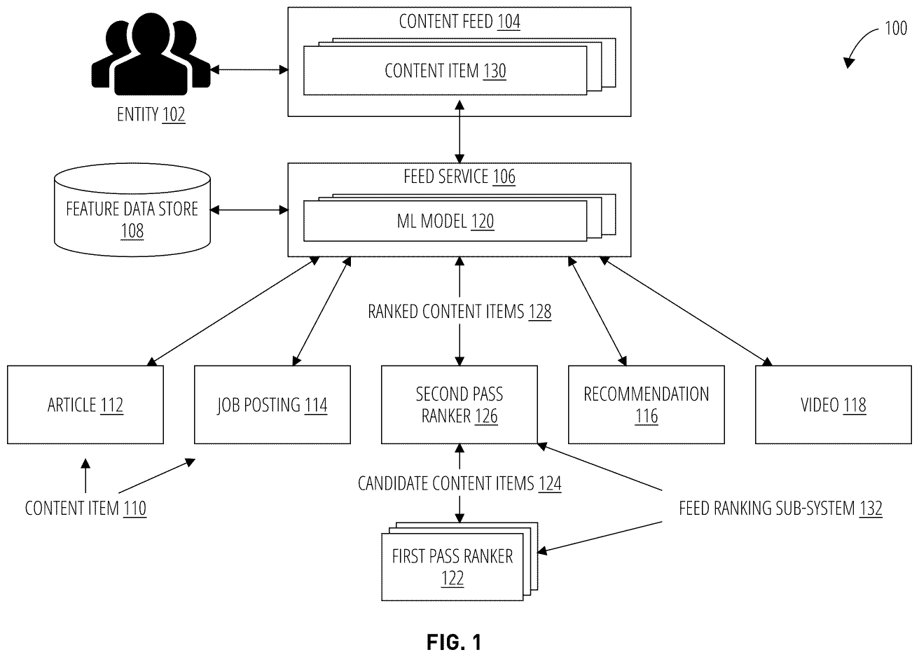

FIG. 1 illustrates a connection network system 100 suitable for implementing various embodiments as described herein.

The connection network system 100 is an online platform that fosters connections, supports career advancement, and facilitates industry-specific collaborations. A connection network system is a membership-based service that caters to users and companies of all sizes. Users can create in-depth profiles highlighting their interests, work experience, education, skills, endorsements, and achievements, enabling them to network strategically, join interest-based groups, play games, and stay informed on industry trends. In addition to its powerful networking capabilities, the connection network system 100 integrates features that assist with interest discovery, enabling individuals to receive personalized job recommendations, apply directly through the platform, and engage with potential employers. Companies leverage network services for talent acquisition, employer branding, company updates, and thought leadership activities, making it a central hub for building a professional presence.

In some embodiments, the connection network system 100 may provide access to a large amount of electronic content aimed at professional networking and career development. For example, the connection network system 100 may list employment opportunities posted by employers across different industries, professional profiles with detailed information about entities of the connection network system (e.g., work experience, skills, and endorsements), articles or posts created by entities and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where entities can share ideas and discuss industry trends, and other types of content designed to facilitate professional growth and industry engagement.

Various types of entities 102 may generate, modify, store, read, or otherwise interact with the electronic content of the connection network system 100. Non-limiting examples of entities 102 include an individual, a member, a person, an entity, a member, a subscriber, a corporate entity, a company, a business, an organization, a governmental agency, a community, a group, and the like. In some cases, the connection network system 100 collects a variety of data associated with the various types of entities 102 of the platform in accordance with privacy policies which govern how this information is collected, used, and shared. For an entity 102 such as a user or member of the connection network system 100, the entity data may include basic profile information such as name, job title, industry, location, educational background, demographic information, work history, and so forth. For an entity 102 such as a company, the entity data may also include basic profile information such as a company name, description, industry, business segment, jobs, careers, offices, geographic locations, and so forth. Additionally, the connection network system 100 may collect activity data for entities 102 representing various interactions and behaviors exhibited while on the platform. Examples of activity data including interactions between entities 102 or interacting with electronic content of the connection network system 100, including profile updates, content engagement, search and navigation behavior, job activities, networking activities, group participation, skill endorsements and recommendations, advertisement engagement, learning activities, event participation, followers activities, interactions with external content, engagement patterns, behavioral trends, organic contents, sponsored contents, sales activities, marketing activities, conversion events, and so forth.

In some cases, the connection network system 100 may enhance network services offered by the connection network system 100 based on the entity data and activity data of its entities 102. Examples of network services include feed services, messaging services, search services, ranking services, recommendation services, advertising services, content delivery services, and so forth. For example, the connection network system 100 may use activity data to personalize entity experiences, optimize content displayed in content feeds 104, improve targeted advertising, and enhance platform features. It also plays a role in developing analytics and reporting tools, helping entities 102 understand their network reach, content effectiveness, and engagement with their audience.

A feed service 106 feeds content items 110 to the content feed 104 for presentation to an entity 102. Examples of content items 110 include articles 112, job postings 114, recommendations 116, videos 118, and so forth. The feed service 106 uses one or more ML models 120 to select content items 110 for the content feed 104 of the entity 102. Before final fine feed ranking, a personalized candidate generation algorithm is applied to tens of thousands of feed updates to select a diverse and unique candidate pool.

The ML model 120 performs candidate generation of content items 110. The feed service 106 uses the ML model 120 to identify the best conversations for members. In a fraction of a second, the ML model 120 scores tens of thousands of posts and ranks the most relevant at the top of the content feed 104. In order to operate at this scale and speed, the feed service 106 uses a feed ranking sub-system 132.

The feed ranking sub-system 132 implements a two-pass funnel architecture, which generates candidate content items 124 in a first pass and ranks them together as ranked content items 128 during a second pass. A first pass ranker 122 is responsible for retrieving candidate content items 124 from a member's network (e.g. posts, news, career updates, etc.) from thousands of potential candidates and relevant out-of-network (OON) recommendations. The first pass ranker 122 maximizes recall, supplying a large set of potential updates to show members. In some cases, multiple first pass rankers 122 generate multiple sets of candidate content items 124 using different signals or algorithms. A second pass ranker 126 gathers updates from different first pass rankers 122 and ranks the accumulated results for precision. The second pass ranker 126 leverages a multi-objective, multi-task framework for combining predictive likelihoods from different ML models 120 into a single combined score for ranking. The final output from this second pass ranker 126 is ranked content items 128, which is a ranked list of the most relevant and valuable content for a given entity 102.

The second pass ranker 126 may implement a ML model 120 using a multi-objective optimization (MOO) framework. The MOO framework attempts to balance three aspects of the content ecosystem: (1) member side optimization from members' knowledge value from content; (2) downstream optimization impact from member's actions to their network; and (3) creator side feedback optimization which provides upstream value to the creator for different actions taken by the member. With respect to member side optimization, this includes passive optimization for passive behaviors (e.g., clicks, dwell time, etc.) and active optimization for active contribution behaviors (e.g., comments, reshares, etc.). A member side optimization model tries to maximize both passive and active optimization via deep neural networks (DNN). It uses a MOO function for balancing the multiple engagement signals that the models learn and optimize, as shown in Equation (1).

[symbol]

Here alpha, beta, gamma and W are all MOO hyper-parameters that are finely tuned to balance tradeoffs and returns from each aspect of the content ecosystem with the goal of maximizing not only the overall user engagement and retention, but also personalization on a member level.

Once the second pass ranker 126 creates a single, personalized list of ranked content items 128 from the candidate content items 124, the feed service 106 then selects content items 130 from the ranked content items 128 for the entity 102. The feed service 106 adds the selected content items 130 to the content feed 104 for presentation to the entity 102. This process is repeated for different entities 102, different sessions, content updates, time periods, model updates, or other changes to the connection network system 100.

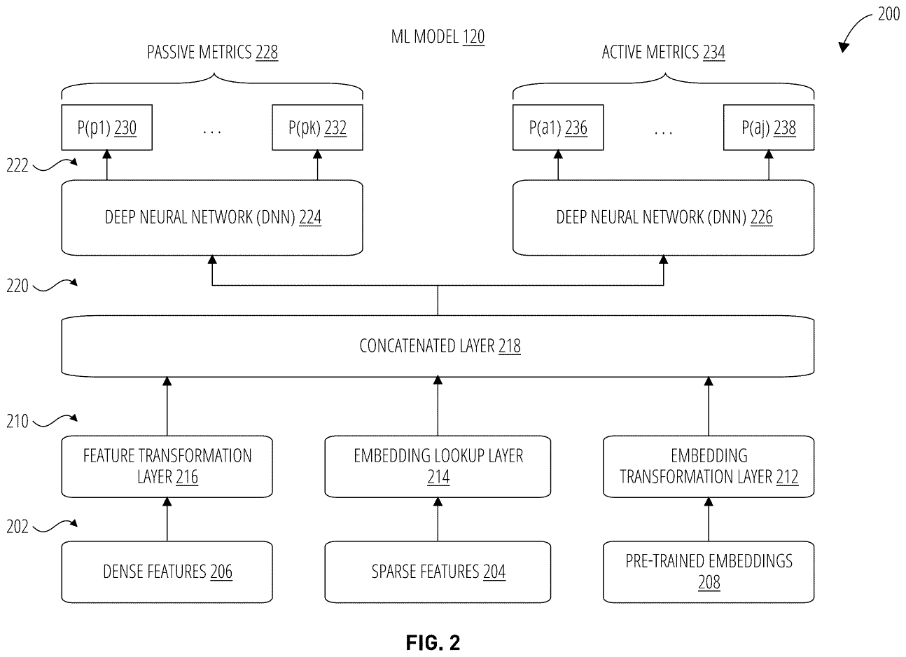

FIG. 2 illustrates a MOO framework 200. The MOO framework 200 is an example framework for an ML model 120 of the feed service 106. Embodiments are not limited to this example.

As depicted in FIG. 2, the MOO framework 200 is implemented for an ML model 120 of the feed service 106 to assist in identifying and selecting content items 110 relevant to an entity 102 for presentation on a content feed 104 of a GUI. In some embodiments, the ML model 120 may support operations for the feed ranking sub-system 132 by providing relevance scores to identify and rank candidate content items 124.

The MOO framework 200 is used by the feed service 106 to help balance different behaviors in the connection network system 100. There are two parts to working with multiple objectives. The first part is about training high-fidelity models to predict member behavior (e.g., probability a member will click an article). The first part of multi-objective optimization utilizes a multi-task, deep learning model to create higher fidelity consumption models. The second part is around trading off different objectives for a unified member experience based on a relative utility to the connection network system 100 (e.g., a comment is much more valuable than a click).

Members of the connection network system 100 rely on the content feed 104 for a variety of content including updates from their network, industry articles, and new job opportunities. Members can engage with this content in multiple ways, including commenting on or resharing posts. One purpose of the relevance system is to understand the different needs of these members and present a personalized experience that provides an ecosystem optimized to foster productive engagement. To this end, the MOO framework 200 is used to rank the many different updates on a content feed 104 of an entity 102 to balance many tradeoffs for a personalized experience. There are two main parts to MOO framework 200. The first is creating models to predict the likelihood of a member taking a certain action on a piece of content, and balancing the many objectives to create a final ranking. For the first part, a standard approach to the problem is to create many individual models, each optimized for a different user behavior. However, this approach limits the learning capability of the overall modeling platform, due to inference latency growth with more computations needed for these objectives and lack of shared learning among related behaviors. To solve this problem, an ML model 120 is jointly trained on multiple objectives in a unified, multi-task learning setup, using deep learning to rank content presented during each visit to the content feed 104 of the entity 102.

Multi-task formulations of machine learning problems allow for joint learning of multiple objectives, exploiting differences and commonalities between objectives to improve performance over separate formulations. The MOO framework 200 uses a deep learning architecture to jointly train on both passive and active consumption objectives, with a specific focus on community sharing objectives. In addition to facilitating shared learning among different objectives, this setup also simplifies the modeling paradigm, with just a single ML model 120 to output response probability for an overall utility function.

In the multi-task learning setup, two groups of objectives are trained with two separate neural networks with common inputs. As depicted in the MOO framework 200, a set of features 202 may comprise sparse features 204, dense features 206, and pre-trained embeddings 208. The sparse features 204 are features (or variables) in a dataset where most of the values are zero or missing. Examples of sparse features 204 include numeric data, categorical data, text data, user-item interaction matrices, and one-hot encodings. The dense features 206 are features (or variables) in a dataset where most values are non-zero and meaningful. Unlike sparse features 204, dense features 206 typically have continuous or categorical values that are present for nearly every data point, resulting in a compact representation with few or no missing or zero values. Examples of dense features 206 include image data, video data, sensor data, normalized features, and embeddings. The pre-trained embeddings 208 are dense, low-dimensional vector representations of data (e.g., words, phrases, images, or entities) that are learned from large, general-purpose datasets by a model before being applied to specific tasks. These embeddings capture semantic relationships and patterns in the data, allowing downstream tasks to leverage this learned knowledge without training from scratch.

The various types of features 202 are transformed into embeddings using a transformation layer 210. For example, an embedding lookup layer 214, such as an XGBoost tree, transforms the sparse features 204 into embeddings for the DNN 222, utili zing the leaves as input categorical features. A feature transformation layer 216, such as Tensorflow, transforms the dense features 206 into embeddings for the DNN 222, relying on batch normalization or projection layers to ensure smooth training. An embedding transformation layer 212 transforms the pre-trained embeddings 208 into embeddings for the DNN 222. The output embeddings from the transformation layer 210 are fed into a concatenated layer 218 to form an input vector 220 for a DNN 222. The output embeddings from the transformation layer 210 are fed into a concatenated layer 218 to form an input vector 220 (or concatenated embedding) for the DNN 222.

For optimal transfer learning among objectives, objectives are grouped into two categories: (1) passive consumption oriented, (2) active consumption oriented. As a result, the DNN 222 is split into two towers representing each category, depicted as DNN 224 and DNN 226 in MOO framework 200. Each DNN 222 is composed of multiple layers of fully connected layers. The DNN 224 outputs a first group of metrics such as passive metrics 228. The passive metrics 228 comprise P(p1) 230 to P(pk) 232, where k is any positive integer. The DNN 226 outputs a second group of metrics such as active metrics 234. The active metrics 234 comprise P(a1) 236 to P(aj) 238, where j is any positive integer. Non-limiting examples of passive metrics 228 comprise a click metric, a skip metric, a follow metric, or a save metric. Non-limiting examples of active metrics 234 comprise a like metric, a share metric, a comment metric, the long dwell metric, a feedback metric, or a total contribution metric. Embodiments are not limited to these examples.

The DNN 222 outputs the passive metrics 228 and the active metrics 234, which are passed to downstream models, such as a click tower or a contribution tower. The downstream models output scores that are used by the feed ranking sub-system 132 to rank candidate content items 124 and ranked content items 128, and the feed service 106 to select content items 110 from the ranked content items 128 for the content feed 104 of the entity 102.

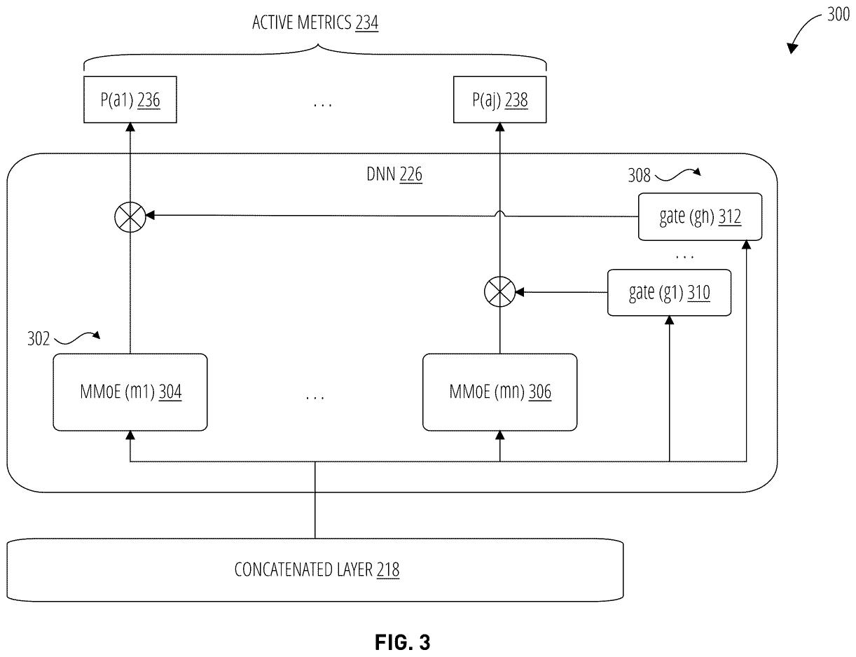

FIG. 3 illustrates a tower architecture 300. The tower architecture 300 is an example of the DNN 226 for generating the active metrics 234 of the MOO framework 200. Embodiments are not limited to this example.

In some embodiments, the DNN 226 may be implemented as an MMoE layer 302. The MMoE layer 302 receives the input vector 220 from the concatenated layer 218, and the MMoE layer 302 generates the active metrics 234. The MMoE layer 302 is a multi-task learning architecture that extends the classic Mixture-of-Experts approach by introducing multiple, task-specific gating networks. In this setup, a pool of “expert” sub-networks (often fully-connected layers) processes the input in parallel, each producing its own output representation. For each task, a dedicated gating network 308, such as gate (g1) 310 to gate (gh) 312, where h represents any positive integer, learns how to weight the outputs of these experts, typically via a softmax mechanism, to yield a task-specific combination of expert outputs. This allows shared parameterization within the experts while enabling each task to learn its own expert-weighting strategy, effectively leveraging cross-task information without forcing all tasks to share the same representation. The MMoE layer 302 yields improved performance across multiple tasks by balancing knowledge sharing with task-specific specialization.

In some embodiments, for example, an MMoE (m1) 304 may be implemented as a combination of a deep and cross network (DCN) and a multilayer perceptron (MLP). However, embodiments may implement an MMoE (m1) 304 using other types of ML architectures and frameworks. Embodiments are not limited to this example. A DCN is a dual-tower architecture that jointly models explicit feature interactions through a “cross” network and higher-order interactions through a “deep” network. The cross network applies multiple cross layers, each computing a bilinear interaction between a base input X₀ and the output of a previous layer Xₗ, formally expressed as follows:

$${X}_{l} + 1 = {X}_{0} ( {X}_{l}^{T} {W}_{l} ) + {b}_{l} + {X}_{l} .$$

The cross layers create direct multiplicative feature interactions without substantial parameter overhead. Simultaneously, the deep network is a standard feed-forward stack that captures complex nonlinear relationships. The outputs of both the cross and deep towers are then combined (e.g., concatenated and fed to a final layer), providing a robust mechanism to incorporate both low-order and high-order feature interactions for tasks such as recommendation or prediction. A MLP is a fully connected neural network composed of multiple layers of linear transformations and non-linear activations. Formally, each hidden layer computes as follows: hₗ=f (Wₗhₗ₋₁+bₗ), where hₗ₋₁ is the input from the previous layer (with h₀) as the original input), Wₗ and bₗ are learnable parameters, and f(·) is a non-linear activation function such as rectified linear unit (ReLU) or sigmoid. The final layer outputs predictions or logits depending on the task (e.g., classification, regression). MLPs are trained end-to-end using backpropagation and gradient-based optimization, and with sufficient depth and width, they can approximate a wide range of continuous functions, making them fundamental building blocks in many deep learning systems.

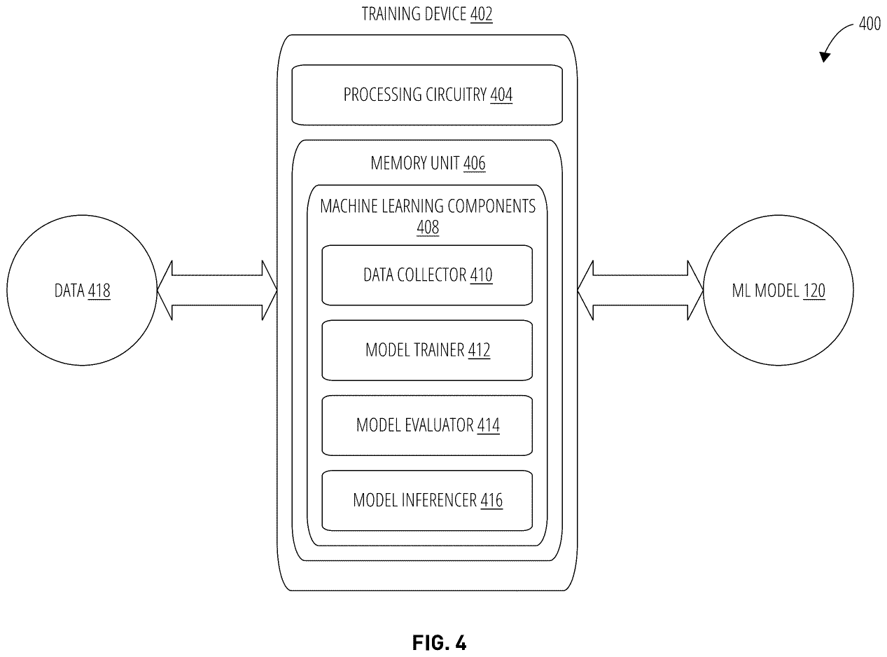

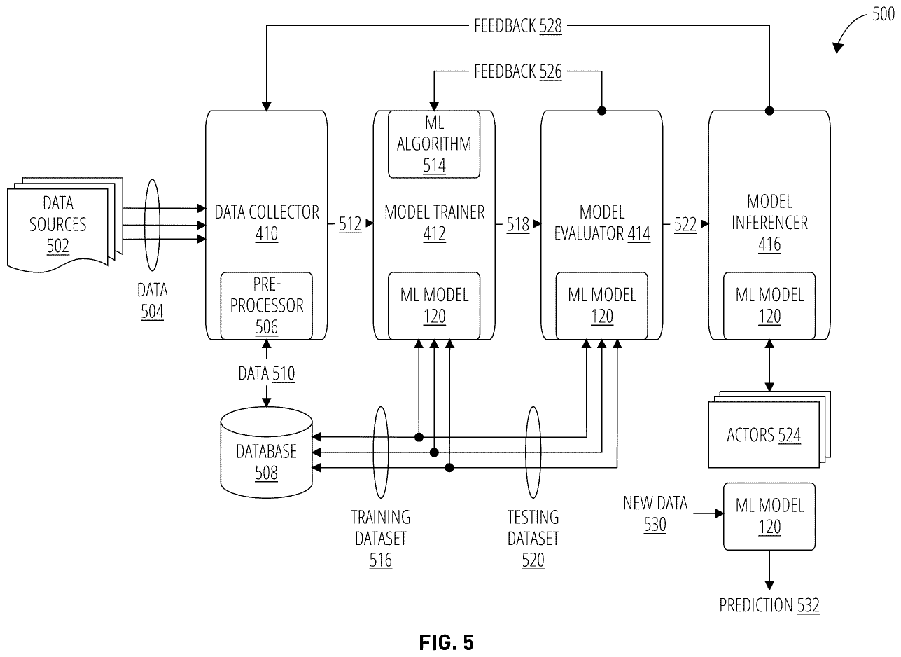

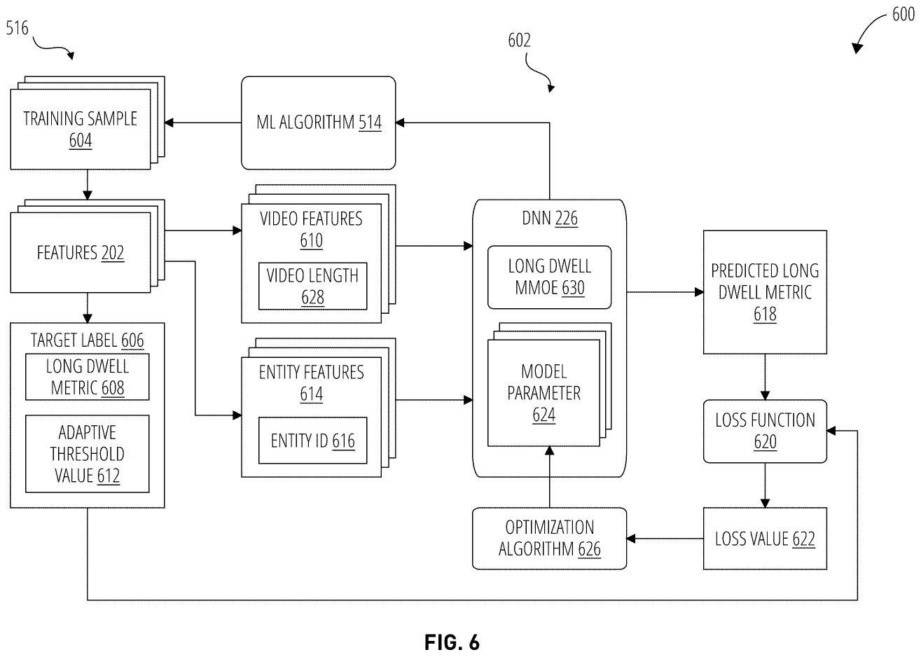

In some embodiments, for example, the MMoE (m1) 304 is designed to generate an active metric from the set of active metrics 234. For instance, the P(a1) 236 may comprise a long dwell metric representing whether an entity 102 will dwell on a content item 110, such as video 118, for a period of time longer than a dynamic adaptive threshold value. The MMoE (m1) 304 in general, and the long dwell metric in particular, are described in further detail with reference to FIG. 4, FIG. 5, and FIG. 6.

FIG. 4 illustrates a training system 400. The training system 400 depicts a training device 402 suitable for training an ML model 120 for the feed service 106 of the connection network system 100. Specifically, the training device 402 trains the ML model 120 to perform inferencing operations in support of the feed ranking sub-system 132 of the feed service 106. Embodiments are not limited to this example.

As depicted in FIG. 4, the training device 402 includes a processing circuitry 404 and a memory unit 406. The memory unit 406 may store a set of ML components 408 to support various AI/ML techniques. The ML components 408 comprise a data collector 410, a model trainer 412, a model evaluator 414 and a model inferencer 416.

In general, the data collector 410 collects data 418 from one or more data sources to use as training data for an ML model 120. The data collector 410 collects different types of data 418, such as text information, audio information, image information, video information, graphic information, entity information, entity activity data, and so forth. The model trainer 412 receives as input the collected data and uses a portion of the collected data as test data for an AI/ML algorithm to train the ML model 120. The model evaluator 414 evaluates and improves the trained ML model 120 using a portion of the collected data as test data to test the ML model 120. The model evaluator 414 also uses feedback information from the deployed ML model 120. The model inferencer 416 implements the trained ML model 120 to receive as input new unseen data, generate one or more inferences on the new data, and output a result such as an alert, a recommendation or other post-solution activity. An exemplary AI/ML architecture for the ML components 408 is described in more detail with reference to FIG. 5.

The training device 402 of the training system 400 is used to train an ML model 120 implementing the MOO framework 200 and DNN 222, such as DNN 224 or DNN 226, of the tower architecture 300. In particular, the training device 402 trains the MMoE (m1) 304 of the DNN 226 to predict a long dwell metric of the set of active metrics 234.

FIG. 5 illustrates a logic diagram 500 suitable for use by the training device 402 to generate the ML model 120 for deployment by an inferencing device of the connection network platform 1012. The logic diagram 500 is an example of a system suitable for implementing various AI techniques and/or ML techniques to perform various training tasks on behalf of the various devices of the connection network system 100.

In one embodiment, the training device 402 trains an ML model 120. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss. To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 402 may pretrain an ML model 120 before training the ML model 120 or trains a pretrained ML model 120. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 500 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 120, evaluate performance of the trained ML model 120, and deploy the tested ML model 120 as the trained ML model 120 in a production environment, and continuously monitor and maintain it.

The ML model 120 is a mathematical construct used to predict outcomes based on a set of input data. The ML model 120 is trained using large volumes of training dataset 516, and it can recognize patterns and trends in the training dataset 516 to make accurate predictions. The ML model 120 is derived from an ML algorithm 514. A data set is fed into the ML algorithm 514 which trains an ML model 120 to “learn” a function that produces mappings between a set of inputs and a set of outputs with a reasonably high accuracy. Given a sufficiently large enough set of inputs and outputs, the ML algorithm 514 finds the function for a given task. This function may even be able to produce the correct output for input that it has not seen during training. A data scientist prepares the mappings, selects and tunes the ML algorithm 514, and evaluates the resulting model performance. Once the ML model 120 is sufficiently accurate on test data, it can be deployed for production use.

The ML algorithm 514 is generally a computational procedure used to identify patterns within data and make inferences or predictions without being explicitly programmed for every scenario. The ML algorithm 514 can process input data, learn from it by adjusting internal parameters, and then apply the learned information to new, unseen data. The ML algorithm 514 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 514 of the logic diagram 500 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naïve Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 5, the logic diagram 500 includes a set of data sources 502 to source data 504 for the training device 402. Data sources 502 may comprise any device capable generating, processing, storing or managing data 504 suitable for a ML system. Examples of data sources 502 include without limitation databases, web scraping, sensors and Internet of Things (IoT) devices, image and video cameras, audio devices, text generators, publicly available databases, private databases, and many other data sources 502. The data sources 502 may be remote from the training device 402 and accessed via a network, local to the training device 402 and accessed via a network interface, or may be a combination of local and remote data sources 502.

The data sources 502 source difference types of data 504. By way of example and not limitation, the data 504 includes structured data from relational databases, such as customer profiles, transaction histories, or product inventories. The data 504 includes unstructured data from websites such as customer reviews, news articles, social media posts, or product specifications. The data 504 includes data from temperature sensors, motion detectors, and smart home appliances. The data 504 includes image data from medical images, security footage, or satellite images. The data 504 includes audio data from speech recognition, music recognition, or call centers. The data 504 includes text data from emails, chat logs, customer feedback, news articles or social media posts. The data 504 includes publicly available datasets such as those from government agencies, academic institutions, or research organizations. These are just a few examples of the many sources of data that can be used for ML systems. It is important to note that the quality and quantity of the data is critical for the success of a machine learning project.

The data 504 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 502 are communicatively coupled to a data collector 410. The data collector 410 gathers relevant data 504 from the data sources 502. Once collected, the data collector 410 may use a pre-processor 506 to make the data 504 suitable for analysis. This involves data cleaning, transformation, and feature engineering. Data preprocessing is a critical step in ML as it directly impacts the accuracy and effectiveness of the ML model 120. The pre-processor 506 receives the data 504 as input, processes the data 504, and outputs pre-processed data 510 for storage in a database 508. Examples for the database 508 includes a hard drive, solid state storage, and/or random access memory (RAM).

The data collector 410 is communicatively coupled to a model trainer 412. The model trainer 412 performs AI/ML model training, validation, and testing which may generate model performance metrics as part of the model testing procedure. The model trainer 412 receives the pre-processed data 510 as input 512 or via the database 508. The model trainer 412 implements a suitable ML algorithm 514 to train an ML model 830 on a set of training dataset 516 from the pre-processed data 510. The training process involves feeding the pre-processed data 510 into the ML algorithm 514 to produce or optimize an ML model 120. The training process adjusts its parameters until it achieves an initial level of satisfactory performance.

The model trainer 412 is communicatively coupled to a model evaluator 414. After an ML model 120 is trained, the ML model 120 needs to be evaluated to assess its performance. This is done using various metrics such as accuracy, precision, recall, and F1 score. The model trainer 412 outputs the ML model 120, which is received as input 512 or from the database 508. The model evaluator 414 receives the ML model 120 as input 518, and it initiates an evaluation process to measure performance of the ML model 120. The evaluation process includes providing feedback 526 to the model trainer 412. The model trainer 412 re-trains the ML model 120 to improve performance in an iterative manner.

The model evaluator 414 is communicatively coupled to a model inferencer 416. The model inferencer 416 provides AI/ML model inference output (e.g., inferences, predictions or decisions). Once the ML model 120 is trained and evaluated, it is deployed in a production environment where it is used to make predictions on new data. The model inferencer 416 receives the evaluated ML model 120 as input 522. The model inferencer 416 uses the evaluated ML model 120 to produce insights or predictions on real data, which is deployed as a final production ML model 120. The inference output of the ML model 120 is use case specific. The model inferencer 416 also performs model monitoring and maintenance, which involves continuously monitoring performance of the ML model 120 in the production environment and making any necessary updates or modifications to maintain its accuracy and effectiveness. The model inferencer 416 provides feedback 526 to the data collector 410 to train or re-train the ML model 120. The feedback 526 includes model performance feedback information, which is used for monitoring and improving performance of the ML model 120.

Some or all of the model inferencer 416 is implemented by various actors 524 in the logic diagram 500, including the ML model 120 of the connection network system 100, for example. The actors 524 use the deployed ML model 120 on new data to make inferences or predictions for a given task, and output a prediction 532. The actors 524 implement the model inferencer 416 locally, or remotely receives outputs from the model inferencer 416 in a distributed computing manner. The actors 524 trigger actions directed to other entities or to itself. The actors 524 provide feedback 528 to the data collector 410 via the model inferencer 416. The feedback 528 comprise data needed to derive training data, inference data or to monitor the performance of the ML model 120 and its impact to the network through updating of key performance indicators (KPIs) and performance counters.

As previously described with reference to FIGS. 1, 2, the connection network system 1000 and/or the training system 400 may implement some or all of the logic diagram 500 to support various use cases and solutions for various AI/ML tasks. In various embodiments, the training device 402 of the training system 400 uses the logic diagram 500 to generate and train the ML model 120 for use by connection network system 100. In one embodiment, for example, the training device 402 may train the ML model 120 as a neural network, such as the DNN 222, the DNN 224, the DNN 226, or the MMoE (m1) 304 to MMoE (mn) 306, as previously described in FIG. 2 and FIG. 3. Other use cases and solutions for AI/ML are possible as well, and embodiments are not limited in this context.

FIG. 6 illustrates a logic diagram 600. The logic diagram 600 is an example of the training system 400 training a DNN 222 according to the logic diagram 500, such as training DNN 226 to generate the active metrics 234, such as P(a1) 236 through P(aj) 238. In some embodiments, for example, the P(a1) 236 is a long dwell metric 608 for content items 110, such as videos 118. Embodiments are not limited to this example.

As previously described, dwell time is an important signal for a MOO framework 200. Dwell time refers to the duration users spend on content or posts. Unlike explicit signals such as likes, comments, and shares, dwell time signals are more abundant and offer broader coverage, capturing the engagement of users who passively consume content. This makes dwell time a critical indicator of not only content quality but also relevance, especially for members who enjoy reading content but may not frequently engage explicitly. For instance, many active users are passive consumers who spend time on the feed without taking any explicit actions. This group of users engages with content by reading and viewing without reacting, highlighting the importance of dwell time as their primary engagement signal. Additionally, dwell time is crucial for evaluating the relevance and engagement of out-of-network content, where interactions are less common. For specific content types, such as videos, dwell time becomes even more significant, as users might spend considerable time watching without necessarily liking, commenting, or sharing. This makes dwell time an important metric for understanding how well different types of content resonate with members.

Dwell time is a positive feedback signal for a MOO framework 200. Therefore, an ML model 120 may use dwell time to predict “long dwell” behavior, where a member spends significant time positively engaging with a post. However, creating this type of ML model 120 involves several technical challenges. For example, using a universal long dwell threshold to build binary classifiers or predicting total dwell time spent on the update prove inadequate. Some of the challenges of this approach include noisy dwell time signals per update, lack of an adaptive threshold, and an introduction of biases through static thresholds.

A first technical challenge is the presence of noisy dwell time signals per update. For example, dwell time signals are inherently noisy. Dwell time is noisy because of various confounding factors, such as ambiguity of intent (e.g., a long dwell time does not always mean high engagement), contextual variability (e.g., content length, user behavior, platform design), a lack of granularity (e.g., how the user interacted with content), susceptibility to manipulation (e.g., clickbait thumbnails, misleading introductions), completion rate (e.g., high completion rates on short videos for convenience not quality), and other metrics. Directly predicting the dwell time value or logarithm of dwell time proves unsuitable due to excessive volatility and lack of bounds. Outliers with extremely high values are often present in the data. Similar patterns are observed across various content types and feed positions.

A second technical challenge is a lack of adaptive threshold. For example, utilizing a universal, static threshold for determining “long dwell” does not effectively capture user preferences relative to inherent dwell time baselines. Manual determination of such a threshold by humans is subjective, lacking systematic consistency and varying from person to person. For instance, a dwell time of 30 seconds could be considered “long” for an image but not for a video. Moreover, it fails to adapt to changes in dwell time distribution over time, where users spend increasingly more time on certain content types over time. Shifts in user behavior occur over time, favoring certain content types over the other within users' networks. In this case, the static universal threshold is unable to adjust to frequent changes within the ecosystem. For example, shifts in content types displayed or the introduction of a new user interface could significantly impact user interactions, rendering the previously chosen static threshold detrimental to ranking algorithms.

A third technical challenge is an introduction of biases through static thresholds. For example, employing a fixed static threshold introduces biases in the modeling process. The model might learn to prioritize update types with longer dwell times, such as long videos, over short articles. Test results indicate a bias introduced by the fixed threshold, as certain content types may rarely exceed a given duration, while others surpass it more easily. Therefore, a goal is to develop a model that promotes engaging posts across all content types rather than favoring a few specific ones.

Addressing these challenges requires the formulation of novel approaches to overcome noise in dwell time signals, develop adaptive thresholds, and avoid biases in the promotion of content types. To this end, the ML model 120 uses a MOO framework 200 comprising a tower architecture 300 to implement a set of DNNs 222, such as DNN 224 and DNN 226 to generate passive metrics 228 and active metrics 234, respectively. The active metrics 234 include P(a1) 236 through P(aj) 238. In some embodiments, for example, the P(a1) 236 is a long dwell metric 608 for content items 110, such as videos 118. The DNN 226 provides an auto-normalized long dwell model for modeling “long dwell” behavior that provides significant effectiveness in driving user retention and possesses the capability to adapt automatically as the ecosystem evolves. For example, the DNN 226 implements an MMoE layer 302 comprising a set of MMoE (m1) 304 through MMoE (mn) 306.

In some embodiments, for example, the MMoE (m1) 304 is a long dwell MMoE 630 implemented as a binary classifier that predicts whether an entity 102 will allocate more time to a video 118 compared to a specific percentage (x %) of its counterparts using an adaptive threshold value 612. The long dwell MMoE 630 implements normalization techniques to address bias and noise in dwell time data. By identifying the top-K attributes that significantly influence dwell time, such as content type, creator type, and distribution method, the long dwell MMoE 630 calculates the percentile (e.g., 90%) of dwell time for each unique combination. This normalization prevents a recommendation model from over-recommending based on these specific attributes, and focuses instead on finding quality content within these attribute categories. The system can be extended to any combination of the categorical features unique to a given online system, such as industry of creator, intent of a post, and so forth.

The adaptive threshold value 612 is dynamic and inferred from real world data. This entire process is performed on a periodic, aperiodic or on-demand basis, ensuring that the percentiles remain dynamic rather than static. This adaptability enables the model to evolve alongside the ecosystem, accommodating changes in user behavior and shifts in content distributions. The output score of the classifier is integrated into the score utility, incorporating an adjustable weight which is used to control the importance of passive consumption utility in ranking.

Specifically, the MMoE (mn) 306 is implemented as a long dwell MMoE 630 designed to generate a P(a1) 236 comprising a long dwell metric 608. The long dwell metric 608 is a measure of how long an entity 102 engages with the content item 110 relative to an adaptive threshold value 612. For example, when the content item 110 is a video 118, a long dwell metric 608 may predict whether an entity 102 will allocate more time to a video 118 compared to a specific percentage (x %) of its counterparts. The adaptive threshold value 612 is derived from a percentile (e.g., 70%, 80%, 90%) of dwell time for each unique combination of top-K attributes, such as content type, creator type, distribution method, and other attributes. The percentile is re-calculated on a period, aperiodic, or on-demand basis to adapt to changes in user behavior and shifts in content distributions, such as a video distribution. A new adaptive threshold value 612 is then derived from the re-calculated percentile. In this manner, the adaptive threshold value 612 is a dynamic value inferred from real world data.

A quantile generation process is used to generate quantiles for calculating the adaptive threshold value 612. The quantile generation process incorporates a completion ratio or normalized completion ratio for videos and dwell time for all content items 110, rather than solely relying on dwell time (or watch time) for video content, such as a video 118. For example, a user might watch just the first few seconds of a video, which can still count as watch time but does not tell the full story of engagement. To solve this technical problem, the long dwell metric 608 considers dwell time and video length. This adjustment provides additional insights into user engagement, particularly for video content, by evaluating how thoroughly users consume the video rather than just the duration of their viewing.

In generating a long dwell metric 608, the long dwell MMoE 630 is trained to use an enhanced quantile generation process for evaluating user engagement with digital content. The enhanced quantile generation process goes beyond traditional reliance on dwell time by incorporating video length and dwell time for content items 110 to provide deeper insights into user interaction. This approach is particularly tailored to video content, aiming to measure how thoroughly users consume videos rather than focusing solely on the duration of their viewing. In some embodiments, for example, a long dwell pipeline uses 80% (P80) long dwell quantiles (value ≥80 quantile is set to 1; otherwise, it is 0) for images, text, and videos.

In some embodiments, for example, the long dwell pipeline is enhanced to introduce an additional quantile for video length, capturing user engagement more granularly while preserving the integrity of current metrics. For instance, the long dwell MMoE 630 generates a long dwell metric 608 as one of the active metrics 234. A new breakdown column is introduced that includes a “video bucket” alongside other key columns, such as platform, actor type, and root object type. The video bucket provides a more comprehensive segmentation of content interaction data. Values for the video bucket are derived from a video distribution. A video distribution refers to a statistical distribution of the durations (or lengths) of videos in a dataset used for training, validation, or testing a model. Video length is usually measured in time (e.g., seconds or minutes) or frames (e.g., number of frames in a video). The video distribution captures the frequency of videos having specific lengths. The video bucket is an advancement that is expected to deliver more accurate insights into content consumption patterns, supporting improved decision-making for content optimization and personalization. An example of video buckets for a video distribution is shown in Table 1 as follows.

TABLE 1

| Video Bucket | Video Length (seconds) |
|---|---|
| 1 | 1-10 |
| 2 | 11-20 |
| 3 | 21-30 |
| 4 | 31-60 |
| 5 | 61-120 |
| 6 | 121-180 |
| 7 | 181-300 |
| 8 | 301-600 |
| 9 | 600+ |

In Table 1, video lengths from 1 to 600+ seconds are segmented into video buckets 1-9. It is worthy to note that the video lengths are placed into video buckets since using continuous values for the video lengths adds too much granularity to the ML model 120 thereby increasing training time to convergence.

A training dataset comprises X number of training samples 604, each of which have a video length 628, that are placed in a corresponding video bucket of Table 1 to form a video distribution. For example, assuming a training dataset 516 comprising 1,000,000 training samples 604, with 400,000 video data (40%), an example of a video distribution is shown in Table 2 as follows.

TABLE 2

| Video Bucket | Count | Percentage |
|---|---|---|
| 9 | 15,000 | 1.50 |
| 8 | 35,000 | 3.50 |
| 7 | 25,000 | 2.50 |
| 6 | 75,000 | 7.50 |
| 5 | 100,000 | 10.00 |
| 4 | 20,000 | 2.00 |
| 3 | 30,000 | 3.00 |
| 2 | 50,000 | 5.00 |
| 1 | 50,000 | 5.00 |
| 0 | 600,000 | 60.00 |

In Table 2, the video buckets 1-9 represent video objects and the video bucket 0 represents all other object types. As indicated in Table 2, video bucket 1 (1-10 seconds) comprises 50,000 video samples or 5.00% of the total number of video samples, while video bucket 9 (600+ seconds) comprises 15,000 video samples or 1.50% of the total number of video samples.

The adaptive threshold value 612 is derived by calculating a set of quantiles of dwell time values for a given combination of attributes. In some embodiments, for example, the attributes may comprise a platform type, an actor type, an object type, and a video bucket value when the object type is a video, the video bucket value indicating a video bucket of video lengths from a video length distribution. The adaptive threshold value 612 is then selected from a quantile of the set of quantiles. For example, assume a breakdown table of breakdown columns such as List(PLATFORM, ACTOR TYPE, OBJECT TYPE, VIDEO BUCKET). An example of a breakdown table using the values from Table 1 and Table 2 is shown in Table 3 as follows.

TABLE 3

| | | Ob- | | | | | | |
|---|---|---|---|---|---|---|---|---|
| Plat- | Actor | ject | Video | | | | | Length |
| form | Type | Type | Bucket | P90 | P80 | P70 | P60 | (s) |
| mobile | member | video | 4 | 60 | 50 | 20 | 15 | 121-180 |
| desktop | member | video | 5 | 90 | 60 | 25 | 10 | 181-300 |
| mobile | member | video | 5 | 80 | 70 | 50 | 40 | 181-300 |
| desktop | member | video | 2 | 40 | 20 | 15 | 10 | 31-60 |
| mobile | member | video | 1 | 10 | 20 | 15 | 5 | 1-30 |

In Table 3, a given combination of mobile, member, video, and video bucket 4 shows 4 (of 10) quantiles P90 through P60 with values [60, 50, 20, 15]. The quantiles indicate, for this combination, that 60% (P60) of the users spend 15 seconds or less on this content, 70% (P70) of the users spend 20 seconds or less on this content, 80% (P80) of the users spend 50 seconds or less on this content, and 90% (P90) of the users spend 60 seconds or less on this content (e.g., object type). An adaptive threshold value 612 is then selected from one of the quantiles. For example, assume the adaptive threshold value 612 is selected from P90, then the adaptive threshold value 612 is set to 60 seconds. This indicates the adaptive threshold value 612 for a long dwell metric 608 is greater than or equal to 60 seconds. In this case, the long dwell MMoE 630 generates a long dwell metric 608 set to a binary value of 1 when video content is interacted with longer than 60 seconds, otherwise it is set to a binary value of 0 (or vice-versa). It is worthy to note that a given percentile (e.g., P60, P70, P80, P90) may be selected by a system designer or automatically by a model manager.

As depicted in FIG. 6, the training system 400 comprises a training device 402 that executes ML algorithm 514 to train the DNN 226 of the ML model 120 to generate a long dwell metric 608 using an adaptive threshold value 612. For example, the ML algorithm 514 trains the long dwell MMoE 630 of the DNN 226 over a set of training iterations 602 using the training samples 604 of the training dataset 516. A training iteration 602 includes retrieving a training sample 604 from the training dataset 516. The training sample 604 comprises a set of features 202 and a target label 606. The set of features 202 comprise video features 610 associated with a video 118 and entity features 614 associated with an entity ID 616. The video features 610 include a video length 628. The target label 606 comprises a long dwell metric 608. The long dwell metric 608 is set to a binary value. The binary value is set to a first binary value when a dwell time for the video is greater than or equal to an adaptive threshold value 612 and a second binary value when the dwell time for the video is less than the adaptive threshold value 612. For example, the first binary value is set to a 1 and the second binary value is set to a 0. Alternatively, the first binary value is set to a 0 and the second binary value is set to a 1. Embodiments are not limited to a binary value, and a continuous value may be used as well. For example, the long dwell metric may be set to a continuous value from a range of probability values of a probability distribution. In some cases, the continuous value may be normalized within a given range, such as 0 to 1.

The DNN 226 receives a set of features 202 including the video features 610 and the entity features 614 as an input vector 220. The video features 610 include a video length categorized into a video bucket as shown in Table 1. The entity features 614 include an entity ID 616 associated with an entity 102. Non-limiting examples for the set of features 202 may include embeddings for post related information, member related information, activity data, group level data, time periods, sliding windows, member rankings, topical rankings, type of actor, platform type, object type, user interactions, and other features. Embodiments are not limited in this context. The DNN 226 comprises one or more MMoE (m1) 304 to MMoE (mn) 306, such as a long dwell MMoE 630. The input vector 220 passes through the long dwell MMoE 630, generating a predicted long dwell metric 618 based on current model parameters 624. The model parameters 624 may comprise weight parameters and/or bias parameters for a neuron in a neural network layer. For example, in a neural network, inputs are multiplied by weight parameters, summed, and passed through activation functions (e.g., ReLU, sigmoid). A loss function 620 generates a loss value 622 between the predicted long dwell metric 618 and the long dwell metric 608 of the target label 606. The loss function 620 aggregates the loss over a batch of training samples 604. Examples for loss function 620 include mean squared error (MSE), mean absolute error (MAE), cross-entropy loss, binary-cross-entropy, a custom loss function, and so forth. The goal is to minimize the loss function during training. A backward pass or backpropagation computes gradients of the loss value 622 with respect to each model parameter 624 using the chain rule. This identifies how much each model parameter 624 contributes to the loss value 622. An optimization algorithm 626 updates the model parameters 624 in the direction that reduces the loss value 622. Examples of the optimization algorithm 626 include gradient descent, stochastic gradient descent (SGD), mini-batch SGD, adaptive optimizer, and so forth.

The ML algorithm 514 executes a next training iteration 602 from the set of training iterations 602 with another training sample 604. This process continues for all the training samples 604 to complete an epoch. An epoch is one full pass through the training dataset 516. The training samples 604 are processed in batches (e.g., 32 samples, 64 samples) to balance computational efficiency and gradient accuracy. In some cases, the training samples 604 are randomized after each epoch. Training typically involves multiple epochs (e.g., 10-100) depending on convergence of the long dwell MMoE 630. Convergence is when the loss value 622 stabilizes, validation performance stops improvement, or a predefined number of epochs is reached. Hyperparameters for the training are set for learning rate, batch size, a number of training iterations 602, a number of epochs, a number of layers, regularization strength, and so forth. Regularization is set to prevent overfitting, such as adding penalties to the loss (e.g., L1/L2 regularization), using dropout in neural networks (e.g., randomly disabling neurons during training), applying data augmentation to increase dataset diversity, randomizing training samples 604 after each epoch, and so forth.

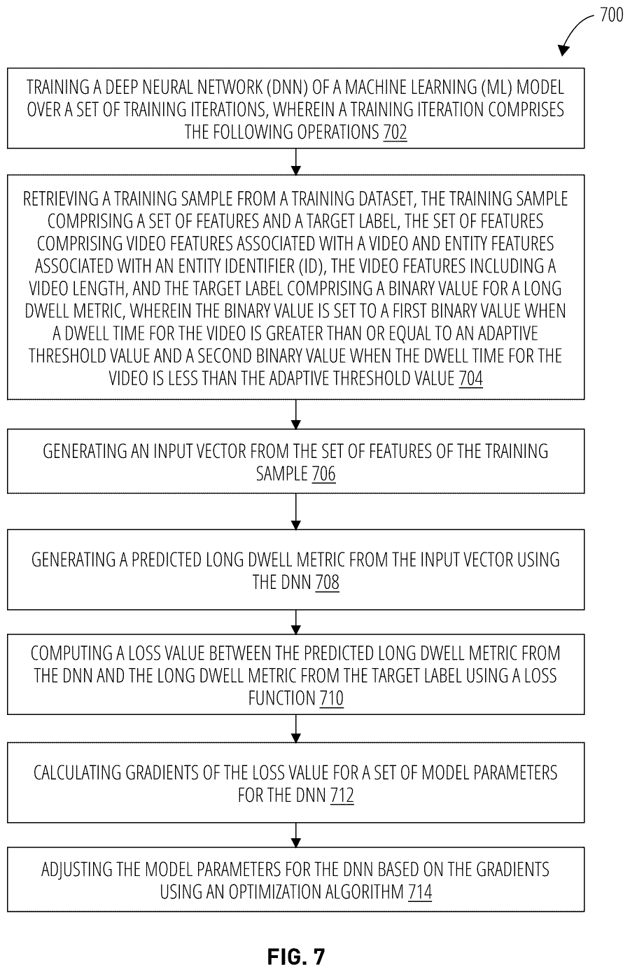

FIG. 7 illustrates an embodiment of a logic flow 700. The logic flow 700 may be representative of some or all of the operations executed by one or more embodiments described herein. For example, the logic flow 700 may include some or all of the operations performed by devices or entities within the connection network system 100, such as the training device 402 of the training system 400. For example, the logic flow 700 may be performed by devices, apparatus, system, and logic for implementing the connection network system 100, MOO framework 200, tower architecture 300, training system 400, logic diagram 500, and/or logic diagram 600.

As depicted in logic flow 700, at block 702, the logic flow 700 includes training a deep neural network (DNN) of a machine learning (ML) model over a set of training iterations, wherein a training iteration comprises a set of operations. At block 704, the logic flow 700 includes retrieving a training sample from a training dataset, the training sample comprising a set of features and a target label, the set of features comprising video features associated with a video and entity features associated with an entity identifier (ID), the video features including a video length, and the target label comprising a binary value for a long dwell metric, wherein the binary value is set to a first binary value when a dwell time for the video is greater than or equal to an adaptive threshold value and a second binary value when the dwell time for the video is less than the adaptive threshold value. At block 706, the logic flow 700 includes generating an input vector from the set of features of the training sample. At block 708, the logic flow 700 includes generating a predicted long dwell metric from the input vector using the DNN. At block 710, the logic flow 700 includes computing a loss value between the predicted long dwell metric from the DNN and the long dwell metric from the target label using a loss function. At block 712, the logic flow 700 includes calculating gradients of the loss value for a set of model parameters for the DNN. At block 714, the logic flow 700 includes adjusting the model parameters for the DNN based on the gradients using an optimization algorithm.

By way of example, the training device 402 of the training system 400 executes an ML algorithm 514 to train the DNN 226 comprising the long dwell MMoE 630 of the tower architecture 300 of the MOO framework 200 for an ML model 120. The ML algorithm 514 trains the long dwell MMoE 630 over a set of training iterations, wherein a training iteration comprises a set of training operations. The ML algorithm 514 includes retrieving a training sample 604 from a training dataset 516. The training sample 604 comprises a set of features 202 and a target label 606. The set of features 202 comprise video features 610 associated with a video 118 and entity features 614 associated with an entity ID 616 of an entity 102. The video features 610 include a video length 628. The target label 606 comprises a binary value for a long dwell metric 608, wherein the binary value is set to a first binary value when a dwell time for the video 118 is greater than or equal to an adaptive threshold value 612 and a second binary value when the dwell time for the video 118 is less than the adaptive threshold value 612. In some embodiments, for example, the long dwell metric 608 comprises a binary value set to 1 or 0. The ML algorithm 514 includes generating an input vector 220 from the set of features 202 of the training sample 604. The long dwell MMoE 630 generates a predicted long dwell metric 618 from the input vector 220. The loss function 620 computes a loss value 622 between the predicted long dwell metric 618 from the long dwell MMoE 630 and the long dwell metric 608 from the target label 606. The ML algorithm 514 calculates gradients of the loss value 622 for a set of model parameters 624 for the long dwell MMoE 630. An optimization algorithm 626 adjusts the model parameters 624 for the long dwell MMoE 630 based on the gradients.

In some embodiments, for example, the long dwell MMoE 630 (or another model) includes calculating a set of quantiles of dwell time values for a combination of a platform type, an actor type, an object type, and a video bucket value when the object type is a video. The video bucket value indicates a video bucket of video lengths from a video length distribution. The long dwell MME 630 selects the adaptive threshold value 612 from a quantile of the set of quantiles.

In some embodiments, for example, the long dwell MMoE 630 (or some other model) re-calculates the set of quantiles of dwell time values based on new data samples collected over a defined time period, and it selects a new adaptive threshold value 612 from a quantile of the re-calculated set of quantiles.

In some embodiments, for example, the ML algorithm 514 calculates a number of training iterations 602 for the set of training iterations 602 based on a batch size and a total number of training samples 604 in the training dataset 516. The ML algorithm 514 trains the long dwell MMoE 630 using batches of training samples 604 of the batch size for the number of training iterations 602. The ML algorithm 514 increments a counter for an epoch indicating the number of training iterations 602 is complete.

In some embodiments, for example, the DNN 226 comprises a set of MMoE sub-networks to generate a set of metrics, such as active metrics 234 comprising P(a1) 236 through P(aj) 238, and wherein a MMoE sub-network of the set of MMoE subnetworks includes the long dwell MMoE 630 to generate the long dwell metric 608.

In some embodiments, for example, the ML algorithm 514 randomizes an order of the training samples 604 in the training dataset 516, and repeats the set of training iterations 602 for a set of epochs defined by a hyperparameter for the long dwell MMoE 630 of the DNN 226.

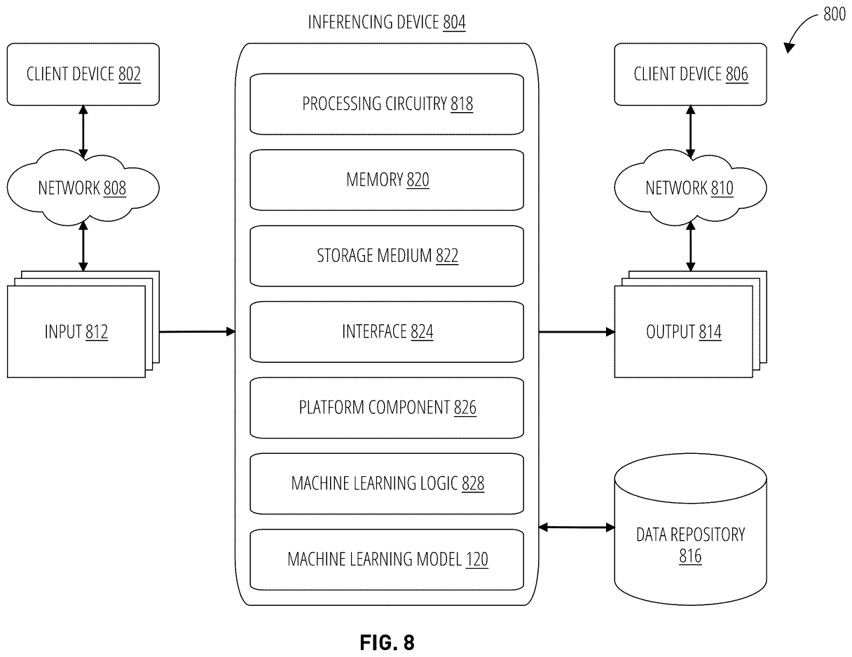

FIG. 8 illustrates an embodiment of an inferencing system 800. The inferencing system 800 is suitable for implementing one or more embodiments as described herein. In one embodiment, for example, the inferencing system 800 is an AI/ML system suitable for implementing models described with reference to any of the preceding description.

The inferencing system 800 comprises a set of M devices, where M is any positive integer. FIG. 8 depicts three devices (M=3), including a client device 802, an inferencing device 804, and a client device 806. The inferencing device 804 communicates information with the client device 802 and the client device 806 over a network 808 and a network 810, respectively. The information may include input 812 from the client device 802 and output 814 to the client device 806, or vice-versa. In one alternative, the input 812 and the output 814 are communicated between the same client device 802 or client device 806. In another alternative, the input 812 and the output 814 are stored in a data repository 816. In yet another alternative, the input 812 and the output 814 are communicated via a platform component 826 of the inferencing device 804, such as an input/output (I/O) device (e.g., a touchscreen, a microphone, a speaker, etc.).

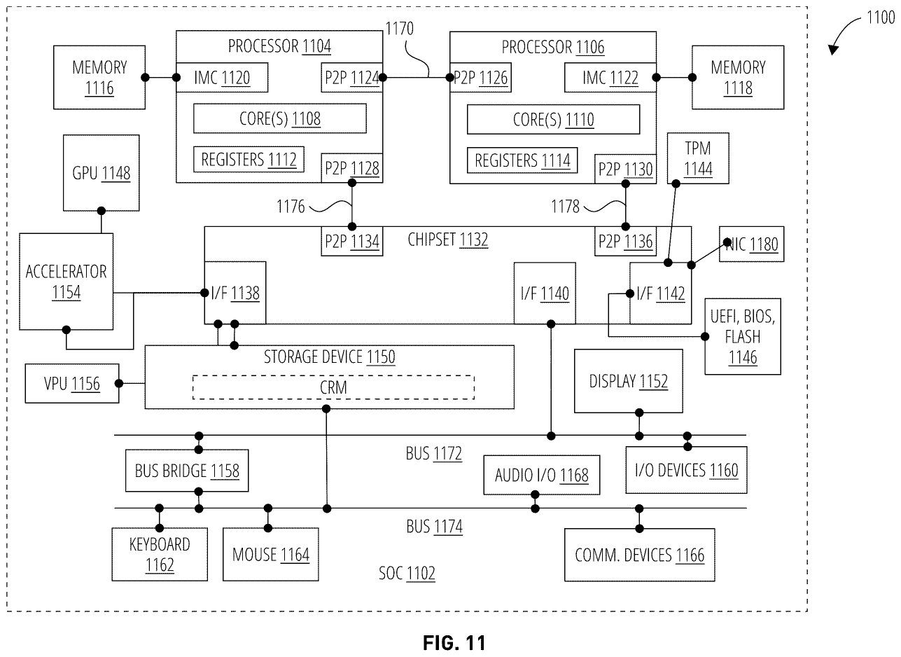

As depicted in FIG. 8, the inferencing device 804 includes processing circuitry 818, a memory 820, a storage medium 822, an interface 824, a platform component 826, ML logic 828, and an ML model 830. In some implementations, the inferencing device 804 includes other components or devices as well. Examples for software elements and hardware elements of the inferencing device 804 are described in more detail with reference to a computing architecture 1100 as depicted in FIG. 11. Embodiments are not limited to these examples.

The inferencing device 804 is generally arranged to receive an input 812, process the input 812 via one or more AI/ML techniques, and send an output 814. The inferencing device 804 receives the input 812 from the client device 802 via the network 808, the client device 806 via the network 810, the platform component 826 (e.g., a touchscreen as a text command or microphone as a voice command), the memory 820, the storage medium 822 or the data repository 816. The inferencing device 804 sends the output 814 to the client device 802 via the network 808, the client device 806 via the network 810, the platform component 826 (e.g., a touchscreen to present text, graphic or video information or speaker to reproduce audio information), the memory 820, the storage medium 822 or the data repository 816.

The inferencing device 804 includes ML logic 828 and an ML model 120 to implement various AI/ML techniques for various AI/ML tasks. The ML logic 828 receives the input 812, and processes the input 812 using the ML model 120. The ML model 120 performs inferencing operations to generate an inference for a specific task from the input 812. In some cases, the inference is part of the output 814. The output 814 is used by the client device 802, the inferencing device 804, or the client device 806 to perform subsequent actions in response to the output 814.

In various embodiments, the ML model 120 is a trained ML model 120 using a set of training operations. An example of training operations to train the ML model 120 is described with reference to FIG. 4, FIG. 5, FIG. 6, and FIG. 7.

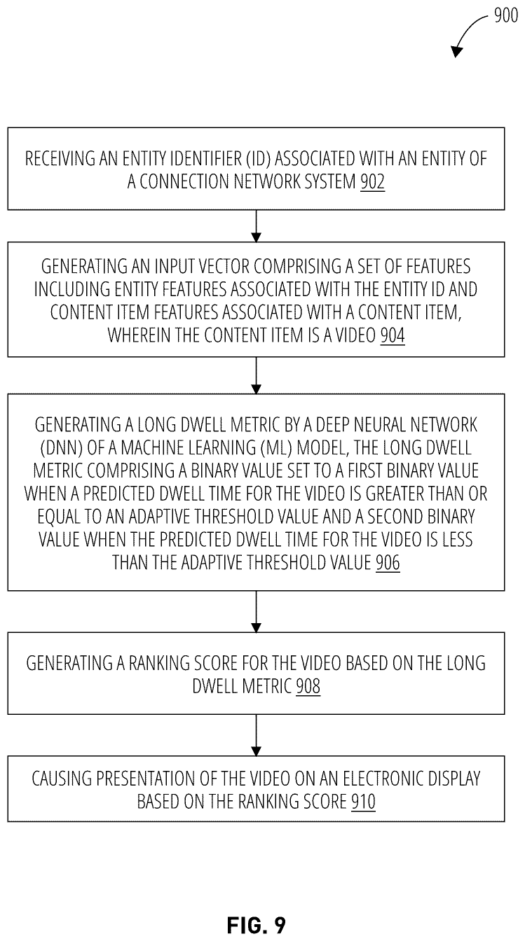

FIG. 9 illustrates an embodiment of a logic flow 900. The logic flow 900 may be representative of some or all of the operations executed by one or more embodiments described herein. For example, the logic flow 900 may include some or all of the operations performed by devices or entities within the connection network system 100, such as the training device 402 of the training system 400, and the inferencing device 804 of the inferencing system 800. More particularly, the logic flow 900 illustrates an example of operations for devices, apparatus, system, and logic for connection network system 100, MOO framework 200, tower architecture 300, training system 400, logic diagram 500, logic diagram 600, and/or logic flow 700.

As depicted in logic flow 900, at block 902, the logic flow 900 includes receiving an entity identifier (ID) associated with an entity of a connection network system. At block 904, the logic flow 900 includes generating an input vector comprising a set of features including entity features associated with the entity ID and content item features associated with a content item, wherein the content item is a video. At block 906, the logic flow 900 includes generating a long dwell metric by a deep neural network (DNN) of a machine learning (ML) model, the long dwell metric comprising a binary value set to a first binary value when a predicted dwell time for the video is greater than or equal to an adaptive threshold value and a second binary value when the predicted dwell time for the video is less than the adaptive threshold value. At block 908, the logic flow 900 includes generating a ranking score for the video based on the dwell metric. At block 910, the logic flow 900 includes causing presentation of the video on an electronic display based on the ranking score.

By way of example, the inferencing device 804 of the inferencing system 800 of the connection network system 100 receives an entity ID 616 associated with an entity 102 of a connection network system 100. The ML logic 828 generates an input vector 220 comprising a set of features 202 including entity features 614 associated with the entity ID 616 and content item features associated with a content item 110, such as video features 610 for a video 118. The long dwell MMoE 630 of the DNN 226 of the ML model 120 generates a long dwell metric 608. The long dwell metric 608 comprises a binary value set to a first binary value when a predicted dwell time for the video is greater than or equal to an adaptive threshold value 612 and a second binary value when the predicted dwell time for the video is less than the adaptive threshold value 612. For example, the first binary value is a 1 and the second binary value is a 0, or alternatively, the first binary value is a 0 and the second binary value is a 1. The feed ranking sub-system 132 generates a ranking score for the video 118 based on the long dwell metric 608. The feed service 106 causes presentation of the video 118 on a content slot of a content feed 104 of a GUI on an electronic display based on the ranking score.

In some embodiments, for example, the long dwell MMoE 630 (or another model) includes calculating a set of quantiles of dwell time values for a combination of a platform type, an actor type, an object type, and a video bucket value when the object type is a video. The video bucket value indicates a video bucket of video lengths from a video length distribution. The long dwell MMoE 630 selects the adaptive threshold value 612 from a quantile of the set of quantiles.

In some embodiments, for example, the long dwell MMoE 630 (or some other model) re-calculates the set of quantiles of dwell time values based on new data samples collected over a defined time period, and it selects a new adaptive threshold value 612 from a quantile of the re-calculated set of quantiles.

In some embodiments, for example, the DNN 226 comprises a set of MME sub-networks to generate a set of metrics, such as active metrics 234 comprising P(a1) 236 through P(aj) 238, and wherein a MMoE sub-network of the set of MMoE subnetworks includes the long dwell MMoE 630 to generate the long dwell metric 608.

In some embodiments, for example, the ML logic 828 generates an input vector, such as input vector 220, from the set of features 202 by a concatenation concatenated layer 218 of the ML model 120.

In some embodiments, for example, the long dwell MMoE 630 of the DNN 226 receives the input vector, generates the long dwell metric 608, and receives a gating signal from a dwell time gate such as gate (g1) 310 of a gating network 308 of the DNN 226. The gating signal comprises a weight parameter for the long dwell MMoE 630. The long dwell MMoE 630 outputs the long dwell metric 608 to an output vector of the ML model 120.

In some embodiments, for example, the DNN 226 comprises an MMoE layer 302 comprising a set of MMoE (m1) 304 through MMoE (mn) 306. The MMoE layer 302 receives the input vector 220 from the set of features 202. The MMoE layer 302 generates a set of metrics such as active metrics 234. The MMoE layer 302 receives a set of gating signals from a set of gates of a gating network 308 of the DNN 226. A gating signal comprises a weight parameter for a given MMoE. The set of weighted metrics are added to an output vector of the ML model 120, wherein the set of metrics passive metrics 228 and active metrics 234, the active metrics 234 including the long dwell metric 608.

In some embodiments, for example, a passive metric of the passive metrics 228 comprises a click metric, a skip metric, a follow metric, or a save metric, and an active metric of the active metrics 234 comprises a like metric, a share metric, a comment metric, the long dwell metric 608, a feedback metric, or a total contribution metric.

In some embodiments, for example, the MME layer 302 outputs the set of metrics to an output vector of the ML model 120. The ML logic 828 sends the output vector to a downstream ML model 120. The downstream ML model 120 receives the output vector as part of an input vector for the downstream ML model 120. An example of a downstream ML model 120 is a feed ranking model for the feed ranking sub-system 132 or a recommendation model for a recommendation sub-system of the connection network system 100.

In some embodiments, for example, the ML logic 828 generates an engagement metric based on the set of metrics using a multi-objective optimization (MOO) function. Non-limiting examples of engagement metrics include a click-through-rate (CTR) value or a contribution value, the CTR value representing a probability that the entity ID 616 will interact with the content item 110 given the set of features 202, and the contribution value representing a measure of contribution of the set of metrics to an objective of the downstream ML model 120.

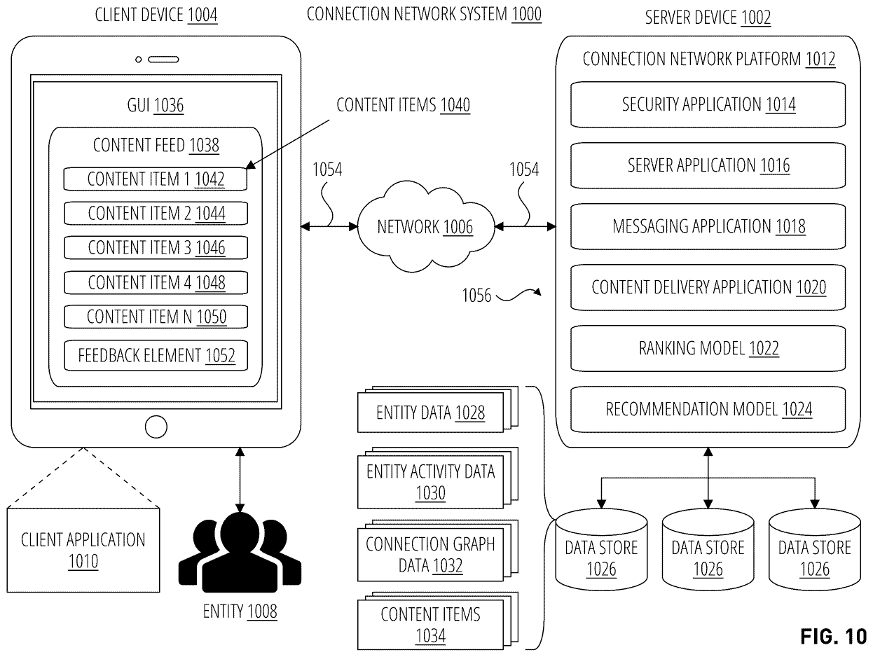

FIG. 10 illustrates a connection network system 1000. The connection network system 1000 is a more detailed example of the connection network system 100. Specifically, the connection network system 1000 is an example of an architecture or framework for an online computer and communications system designed to serve content items to an electronic device associated with a user. Embodiments are not limited to this example.

In general, the connection network system 1000 may include a variety of servers, sub-systems, programs, modules, logs, and data stores. In particular embodiments, the connection network system 1000 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 1000 may also include suitable components such as network interfaces, security mechanisms, load balancers, failover servers, management-and-network-operations consoles, privacy software, and other suitable components, or any suitable combination thereof.

As depicted in FIG. 10, the connection network system 1000 comprises a server device 1002 communicating with a client device 1004 over a network 1006. Additionally, or alternatively, the client device 1004 may communicate with another client device 1004 in a peer-to-peer (P2P) mode or via the server device 1002. In operation, an entity 1008 interacts with a client application 1010 of the client device 1004 to access applications and services provided by a connection network platform 1012 of the server device 1002. The connection network platform 1012 offers a number of network services 1056 for the connection network system 1000, such as network services provided by a security application 1014, a server application 1016, a messaging application 1018, a content delivery application 1020, a ranking model 1022, and/or a recommendation model 1024. The server device 1002 has access to one or more data stores 1026. The data stores 1026 store information for the connection network platform 1012, such as entity data 1028, entity activity data 1030, connection graph data 1032, and content items 1034.

The connection network system 1000 comprises a server device 1002. In particular embodiments, a server device 1002 may be an electronic device including hardware, software, or embedded logic components or a combination of two or more such components and capable of carrying out the appropriate functionalities implemented or supported by a server device 1002. The server device 1002 may comprise a unitary server or a distributed server spanning multiple computers or multiple data centers. The server device 1002 may comprise one or more physical servers or virtual servers hosting one or more networking applications. As an example and not by way of limitation, a server device 1002 may comprise part of a larger server system comprising multiple server devices organized as a data center, an edge computing center, or a cloud-computing center. This disclosure contemplates any suitable server device 1002. A server device 1002 may be accessed by a network entity 1008 at a client device 1004 via the network 1006. A client device 1004 may enable its entity 1008 to communicate with other entities 1008 at the server device 1002, such as via messaging applications 1018.

In one embodiment, for example, the server device 1002 may be implemented as a web server. The web server may be used for linking the connection network platform 1012 to one or more of the client devices 1004 via a network 1006. The web server may include a mail server or other messaging functionality for receiving and routing messages between the connection network platform 1012 and one or more client devices 1004. An API-request server may allow a gaming platform, a third-party system, a messaging system, and/or an AI system to access information from the connection network platform 1012 by calling one or more APIs. An action logger may be used to receive communications from a web server about a user's actions on or off the connection network platform 1012. In conjunction with the action log, a third-party-content-object log may be maintained of user exposures to third-party-content objects. A notification controller may provide information regarding content objects to a client device 1004. Information may be pushed to a client device 1004 as notifications, or information may be pulled from a client device 1004 responsive to a request received from a client device 1004. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 1012 or shared with other systems (e.g., a third-party system), such as, for example, by setting appropriate privacy settings. Third-party-content-object stores may be used to store content objects received from third parties, such as a third-party system. Location stores may be used for storing location information received from client device 1004 associated with users. Advertisement-pricing modules may combine connections information, the current time, location information, or other suitable information to provide relevant advertisements, in the form of notifications, to a user.

The connection network system 1000 comprises a connection network platform 1012. In particular embodiments, the connection network platform 1012 may be part of a network-addressable computing system that can host an online connection network. The connection network platform 1012 may generate, store, receive, and send connection networking data, such as, for example, entity data 1028 (e.g., user-profile data, concept-profile data, etc.), entity activity data 1030 (e.g., user interactions with connection network platform 1012), connection graph data 1032 (e.g., connections between users or entities), content items 1034, or other suitable data related to the online connection network. The connection network platform 1012 may be accessed by the other components of the connection network system 1000 either directly or via a network 1006. As an example and not by way of limitation, a client device 1004 may access the connection network platform 1012 using the client application 1010, which may be a web browser or a native application associated with the connection network platform 1012 (e.g., a mobile connection network application, another suitable application, or any combination thereof) either directly or via a network 1006.

The connection network platform 1012 comprises a security application 1014. In particular embodiments, a security application 1014 may be an application or electronic device including hardware, software, or embedded logic components or a combination of two or more such components and capable of carrying out the appropriate functionalities implemented or supported by the security application 1014. The security application 1014 is a network security system that encompasses a suite of technologies, policies, and practices designed to protect the integrity, confidentiality, and availability of data within the connection network platform 1012 from unauthorized access, attacks, and other security threats. The security application 1014 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 1014 implements security practices to ensure a robust defense against a wide array of cyber threats, safeguarding organizational assets and maintaining trust with stakeholders.

The connection network platform 1012 comprises a server application 1016. In particular embodiments, the server application 1016 may be a web server to serve content information, such as content items 1034, to the client application 1010 of the client device 1004. The server device 1002 may accept an HTTP request and communicate to a client device 1004 one or more HTML files responsive to the HTTP request. The server device 1002 may send HTML files representing a webpage with content information for presentation via an electronic display of the client device 1004 to the entity 1008.

In particular embodiments, the server application 1016 may be an application operable to provide various computing functionalities, services, and/or resources, and to send data to and receive data from the other entities of the network 1006, such as the client device 1004, the connection network platform 1012, a third-party server, and other electronic devices within the connection network system 1000. For example, the server application 1016 may be an e-commerce application, a content application, an advertisement application, a web interface, a messaging application, a video application, a webpage, and so forth.

In particular embodiments, the server application 1016 may be an application for managing various applications and services provided by the online connection network hosted on the connection network platform 1012. In particular embodiments, the server application 1016 may include hardware, software, or embedded logic components or a combination of two or more such components for carrying out the appropriate functionalities implemented or supported by connection network platform 1012. Although the server device 1002 is shown with a single server application 1016, it should be noted that this is not by any way limiting and this disclosure contemplates any number of server applications 1016.

The connection network platform 1012 comprises a messaging application 1018. The messaging application 1018 is software that enables users to send and receive messages, including text, images, videos, and other multimedia content, over a network 1006, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 1012 comprises a content delivery application 1020. The content delivery application 1020 is a software tool that allows users to efficiently deliver content items to other users of the connection network platform 1012 of the connection network system 1000, such as content items 1034 stored by one or more data stores 1026 or third-party content servers. An example for the content delivery application 1020 is a demand-side platform (DSP) used by users such as employees (e.g., an account manager) for an advertising entity. A DSP allows advertisers to purchase and manage ad inventory from multiple ad exchanges and networks through a single interface to implement marketing solutions for products or services of the advertiser. The content delivery application 1020 allows advertisers to create, manage, and analyze their ad campaigns on the platform in accordance with a larger programmatic advertising strategy. It allows for precise targeting based on entity data 1028 and/or entity activity data 1030, making it especially useful for business-to-business (B2B) or business-to-consumer (B2C) marketing campaigns. The content delivery application 1020 delivers content items 1034, such as a series of one or more advertisements, to an audience of entities 1008 of the connection network platform 1012 of the connection network system 1000. The content delivery application 1020 assist advertisers in delivering content and ads to a professional audience by leveraging user profiles, job titles, industries, and other entity data 1028 and entity activity data 1030 collected by the connection network platform 1012.

The connection network platform 1012 comprises various machine learning (ML) models, such as a ranking model 1022. A ranking model 1022 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 1012 to surface the most relevant results or recommendations to users.

The connection network platform 1012 comprises various ML models, such as a recommendation model 1024. A recommendation model 1024 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 1002 comprises, or has access to, one or more data stores 1026. In particular embodiments, the connections networking system 1002 may include a data store 1026. The data store 1026 may be used to store various types of information for the server device 1002 and/or the connection network platform 1012. In particular embodiments, the information stored in the data store 1026 may be organized according to specific data structures. In particular embodiments, the data store 1026 may be a relational, columnar, correlation, or other suitable database. Although this disclosure describes or illustrates particular types of databases, this disclosure contemplates any suitable types of databases. Particular embodiments may provide interfaces that enable a client device 1004 or a connection network system 1000 to manage, retrieve, modify, add, or delete, the information stored in the data store 1026.

In one embodiment, for example, the data store 1026 stores entity data 1028 for the connection network platform 1012. In particular embodiments, the connection network platform 1012 may include entity data 1028 for various entities of the connection network platform 1012. Non-limiting examples of entities may include users, individuals, members, businesses, companies, organizations, software agents, hardware agents, and so forth. For example, the entity data 1028 may comprise one or more user profiles associated with users of the connection network platform 1012. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 1026 stores entity activity data 1030 for the connection network platform 1012. The entity activity data 1030 represents various activities recorded for an entity 1008 by the connection network platform 1012. In particular embodiments, the connection network platform 1012 may provide entities (e.g., users) with the ability to take actions on various types of items or objects supported (or accessible) by connection network platform 1012. As an example and not by way of limitation, the items and objects may include groups or connections networks to which users of the connection network platform 1012 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 1012 or by an external system of a third-party system, which is separate from the server device 1002 and coupled to the server device 1002 via a network 1006.

In one embodiment, for example, the data store 1026 stores connection graph data 1032 for the connection network platform 1012. The connection network platform 1012 may store connection graph data 1032 for one or more users (e.g., members with subscription accounts) of the connection network platform 1012. In one embodiment, for example, connection graph data 1032 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 1012 may provide users of the online connection network system 1000 the ability to communicate and interact with other users. In particular embodiments, users may join the online connection network platform 1012 via the connection network system 1000 and then add connections (e.g., relationships) to a number of other users of the connection network platform 1012 to whom they want to be connected. Herein, the term “connection” may refer to any other user of the connection network platform 1012 or the connection network system 1000 with whom a user has formed a friendship, association, or relationship via the connection network platform 1012.

In one embodiment, for example, the data store 1026 stores content items 1034 for the connection network platform 1012. The content items 1034 may comprise any type of multimedia content, such as text files, multimedia files, image files, video files, graphic files, movies, articles, user feeds, advertisements for a content delivery campaign, banners, recommendations, games, messages, emojis, program code, animations, and so forth. In particular embodiments, the connection network platform 1012 also includes user-generated content (UGC) objects, which may enhance a user's interactions with the connection network platform 1012. User-generated content may include anything a user can add, upload, send, message, or “post” to the connection network platform 1012. As an example and not by way of limitation, a user communicates posts to the connection network platform 1012 from a client device 1004. Posts may include data such as status updates or other textual data, articles, job openings, company information, awards, location information, photos, videos, links, music or other similar data or media. Content may also be added to the connection network platform 1012 by a third-party through a “communication channel,” such as a newsfeed or content stream.

The connection network system 1000 comprises a client device 1004. In particular embodiments, a client device 1004 may be an electronic device including hardware, software, or embedded logic components or a combination of two or more such components and capable of carrying out the appropriate functionalities implemented or supported by a client device 1004. As an example and not by way of limitation, a client device 1004 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 1004. A client device 1004 may enable a network user at a client device 1004 to access a network 1006. A client device 1004 may enable its entity 1008 to communicate with other entities 1008 at other client devices 1004, such as via messaging application 1018.

The connection network system 1000 comprises a client application 1010. In particular embodiments, a client device 1004 may include a client application 1010, which may be a web browser, and may have one or more add-ons, plug-ins, or other extensions. An entity 1008 at a client device 1004 may enter a Uniform Resource Locator (URL) or other address directing a web browser to a particular server device 1002 such as a server or server data center for a connection network platform 1012, and the web browser may generate a Hyper Text Transfer Protocol (HTTP) request and communicate the HTTP request to the server device 1002. The server device 1002 may accept the HTTP request and communicate to a client device 1004 one or more Hyper Text Markup Language (HTML) files responsive to the HTTP request. The client device 1004 may render a web interface (e.g. a webpage) based on the HTML files from the server for presentation via an electronic display of the client device 1004 to the entity 1008. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 1010 may be an application operable to provide various computing functionalities, services, and/or resources, and to send data to and receive data from the other entities of the network 1006, such as the connection network platform 1012. For example, the client application 1010 may be a client connection network application tightly integrated with the connection network platform 1012, a messaging application 1018 for messaging with entities 1008 of a messaging network or system, a web browser application, an internet searching application, and so forth.

In particular embodiments, the client application 1010 may be storable in a memory and executable by a processor circuitry of the client device 1004 to render user interfaces, receive user input, send data to and receive data from the connection network platform 1012. The client application 1010 may generate and present user interfaces to a user via an electronic display of the client device 1004. For example, the client application 1010 may generate and present a GUI 1036 based at least in part on information received from the server device 1002, the connection network platform 1012, and/or another device or system (e.g., a third party server) via the network 1006.

In some embodiments, the connection network platform 1012 and/or the client application 1010 and/or an operating system of the client device 1004 may generate a GUI 1036 on an electronic display of the client device 1004. The client application 1010 may receive one or more content items 1034 from the data store 1026 of the connection network platform 1012 from the content delivery application 1020. The client application 1010 may display the content items 1034 as content items 1040 on a content feed 1038 of the GUI 1036. The content items 1040 may include a feedback element 1052 that when selected or activated by the entity 1008, causes the GUI 1036 to generate a signal such as a message for delivery to the content delivery application 1020 of the connection network platform 1012. The signal or message may comprise a feedback signal to the content delivery application 1020 for use by the content delivery application 1020 to select a new content item from the data store 1026 for delivery to the client device 1004. For example, the content delivery application 1020 may use the feedback signal as part of an ML model to select content items 1034 for a marketing campaign managed by the content delivery application 1020.

The connection network system 1000 comprises a network 1006. This disclosure contemplates any suitable network 1006. As an example and not by way of limitation, one or more portions of a network 1006 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 1006 may comprise multiple networks 1006.

In operation, an entity 1008 interacts with a client application 1010 of the client device 1004 to access applications and services provided by a connection network platform 1012 of the server device 1002 via one or more links 1054 of the network 1006. The links 1054 may connect each client device 1004 to the connection network platform 1012 via the network 1006. This disclosure contemplates any suitable link 1054. In particular embodiments, one or more links 1054 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 1054 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 1054, or a combination of two or more such links 1054. Links 1054 need not necessarily operate at the same throughout. One or more first links 1054 may differ in one or more respects from one or more second links 1054.

FIG. 11 illustrates an embodiment of a computing architecture 1100. Computing architecture 1100 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1100 has a single processor with one core or more than one processor. Note that the term “processor” refers to a processor with a single core or a processor package with multiple processor cores. In at least one embodiment, the computing architecture 1100 is representative of the components of the inferencing system 800. More generally, the computing architecture 1100 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1100. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 11, computing architecture 1100 comprises a system-on-chip (SoC) 1102 for mounting platform components. System-on-chip (SoC) 1102 is a point-to-point (P2P) interconnect platform that includes a first processor 1104 and a second processor 1106 coupled via a point-to-point interconnect 1170 such as an Ultra Path Interconnect (UPI). In other embodiments, the computing architecture 1100 is another bus architecture, such as a multi-drop bus. Furthermore, each of processor 1104 and processor 1106 are processor packages with multiple processor cores including core(s) 1108 and core(s) 1110, respectively. While the computing architecture 1100 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1104 and chipset 1132. Some platforms include additional components and some platforms include sockets to mount the processors and/or the chipset. Furthermore, some platforms do not have sockets (e.g. SoC, or the like). Although depicted as a SoC 1102, one or more of the components of the SoC 1102 are included in a single die package, a multi-chip module (MCM), a multi-die package, a chiplet, a bridge, and/or an interposer. Therefore, embodiments are not limited to a SoC.

The processor 1104 and processor 1106 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1104 and/or processor 1106. Additionally, the processor 1104 need not be identical to processor 1106.

Processor 1104 includes an integrated memory controller (IMC) 1120 and point-to-point (P2P) interface 1124 and P2P interface 1128. Similarly, the processor 1106 includes an IMC 1122 as well as P2P interface 1126 and P2P interface 1130. IMC 1120 and IMC 1122 couple the processor 1104 and processor 1106, respectively, to respective memories (e.g., memory 1116 and memory 1118). Memory 1116 and memory 1118 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1116 and the memory 1118 locally attach to the respective processors (i.e., processor 1104 and processor 1106). In other embodiments, the main memory couple with the processors via a bus and shared memory hub. Processor 1104 includes registers 1112 and processor 1106 includes registers 1114.

Computing architecture 1100 includes chipset 1132 coupled to processor 1104 and processor 1106. Furthermore, chipset 1132 are coupled to storage device 1150, for example, via an interface (I/F) 1138. The I/F 1138 may be, for example, a Peripheral Component Interconnect-enhanced (PCIe) interface, a Compute Express Link® (CXL) interface, or a Universal Chiplet Interconnect Express (UCIe) interface. Storage device 1150 stores instructions executable by circuitry of computing architecture 1100 (e.g., processor 1104, processor 1106, GPU 1148, accelerator 1154, vision processing unit 1156, or the like). For example, storage device 1150 can store instructions for the client device 802, the client device 806, the inferencing device 804, the training device 402, or the like.

Processor 1104 couples to the chipset 1132 via P2P interface 1128 and P2P 1134 while processor 1106 couples to the chipset 1132 via P2P interface 1130 and P2P 1136. Direct media interface (DMI) 1176 and DMI 1178 couple the P2P interface 1128 and the P2P 1134 and the P2P interface 1130 and P2P 1136, respectively. DMI 1176 and DMI 1178 is a high-speed interconnect that facilitates, e.g., eight Giga Transfers per second (GT/s) such as DMI 3.0. In other embodiments, the processor 1104 and processor 1106 interconnect via a bus.

The chipset 1132 comprises a controller hub such as a platform controller hub (PCH). The chipset 1132 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1132 comprises more than one controller hub such as a chipset with a memory controller hub, a graphics controller hub, and an input/output (I/O) controller hub.

In the depicted example, chipset 1132 couples with a trusted platform module (TPM) 1144 and UEFI, BIOS, FLASH circuitry 1146 via I/F 1142. The TPM 1144 is a dedicated microcontroller designed to secure hardware by integrating cryptographic keys into devices. The UEFI, BIOS, FLASH circuitry 1146 may provide pre-boot code. The I/F 1142 may also be coupled to a network interface circuit (NIC) 1180 for connections off-chip.

Furthermore, chipset 1132 includes the I/F 1138 to couple chipset 1132 with a high-performance graphics engine, such as, graphics processing circuitry or a graphics processing unit (GPU) 1148. In other embodiments, the computing architecture 1100 includes a flexible display interface (FDI) (not shown) between the processor 1104 and/or the processor 1106 and the chipset 1132. The FDI interconnects a graphics processor core in one or more of processor 1104 and/or processor 1106 with the chipset 1132.

The computing architecture 1100 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1154 and/or vision processing unit 1156 are coupled to chipset 1132 via I/F 1138. The accelerator 1154 is representative of any type of accelerator device (e.g., a data streaming accelerator, cryptographic accelerator, cryptographic co-processor, an offload engine, etc.). One example of an accelerator 1154 is the Intel® Data Streaming Accelerator (DSA). The accelerator 1154 is a device including circuitry to accelerate copy operations, data encryption, hash value computation, data comparison operations (including comparison of data in memory 1116 and/or memory 1118), and/or data compression. Examples for the accelerator 1154 include a USB device, PCI device, PCIe device, CXL device, UCIe device, and/or an SPI device. The accelerator 1154 also includes circuitry arranged to execute machine learning (ML) related operations (e.g., training, inference, etc.) for ML models. Generally, the accelerator 1154 is specially designed to perform computationally intensive operations, such as hash value computations, comparison operations, cryptographic operations, and/or compression operations, in a manner that is more efficient than when performed by the processor 1104 or processor 1106. Because the load of the computing architecture 1100 includes hash value computations, comparison operations, cryptographic operations, and/or compression operations, the accelerator 1154 greatly increases performance of the computing architecture 1100 for these operations.

The accelerator 1154 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1154. For example, the accelerator 1154 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1154 via a non-posted write (e.g., a deferred memory write (DMWr)). One example of an instruction that atomically submits a work descriptor to the shared work queue of the accelerator 1154 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1154. The dedicated work queue may accept job submissions via commands such as the movdir64b instruction.

Various I/O devices 1160 and display 1152 couple to the bus 1172, along with a bus bridge 1158 which couples the bus 1172 to a second bus 1174 and an I/F 1140 that connects the bus 1172 with the chipset 1132. In one embodiment, the second bus 1174 is a low pin count (LPC) bus. Various input/output (I/O) devices couple to the second bus 1174 including, for example, a keyboard 1162, a mouse 1164 and communication devices 1166.

Furthermore, an audio I/O 1168 couples to second bus 1174. Many of the I/O devices 1160 and communication devices 1166 reside on the system-on-chip (SoC) 1102 while the keyboard 1162 and the mouse 1164 are add-on peripherals. In other embodiments, some or all the I/O devices 1160 and communication devices 1166 are add-on peripherals and do not reside on the system-on-chip (SoC) 1102.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

What is claimed is:

1. A method, comprising:
training a deep neural network (DNN) of a machine learning (ML) model over a set of training iterations, wherein a training iteration comprises:
retrieving a training sample from a training dataset, the training sample comprising a set of features and a target label, the set of features comprising video features associated with a video and entity features associated with an entity identifier (ID), the video features including a video length, and the target label comprising a value for a long dwell metric representing when a dwell time for the video is greater than or equal to an adaptive threshold value;
generating a predicted long dwell metric from the set of features using the DNN;
computing a loss value between the predicted long dwell metric and the long dwell metric using a loss function; and
adjusting a set of model parameters for the DNN based on the loss value.

2. The method of claim 1, comprising:
calculating a set of quantiles of dwell time values for a combination of an actor type, an object type, and a video bucket value when the object type is a video, the video bucket value indicating a video bucket of video lengths from a video length distribution; and
selecting the adaptive threshold value from a quantile of the set of quantiles.

3. The method of claim 2, comprising:
re-calculating the set of quantiles of dwell time values based on new data samples collected over a defined time period; and
selecting a new adaptive threshold value from a quantile of the re-calculated set of quantiles.

4. The method of claim 1, wherein the long dwell metric comprises a binary value set to 1 or 0.

5. The method of claim 1, wherein the target label comprises a binary value for the long dwell metric, wherein the binary value is set to a first binary value when the dwell time for the video is greater than or equal to the adaptive threshold value and a second binary value when the dwell time for the video is less than the adaptive threshold value.

6. The method of claim 5, wherein the target label comprises a continuous value for the long dwell metric.

7. The method of claim 1, wherein the DNN comprises a set of multi-gate mixture-of-experts (MMoE) sub-networks to generate a set of metrics, wherein a MMoE sub-network of the set of MMoE subnetworks generates the long dwell metric.

8. A method, comprising:
receiving an entity identifier (ID) associated with an entity of a connection network system;
generating an input vector comprising a set of features including entity features associated with the entity ID and content item features associated with a content item, wherein the content item is a video;
generating a long dwell metric by a deep neural network (DNN) of a machine learning (ML) model, the long dwell metric representing when a dwell time for the video is greater than or equal to an adaptive threshold value;
generating a ranking score for the video based on the long dwell metric; and
causing presentation of the video on an electronic display based on the ranking score.

9. The method of claim 8, comprising:
calculating a set of quantiles of dwell time values for a combination of an actor type, an object type, and a video bucket value when the object type is a video, the video bucket value indicating a video bucket of video lengths from a video length distribution; and
selecting the adaptive threshold value from a quantile of the set of quantiles.

10. The method of claim 8, comprising:
re-calculating the set of quantiles of dwell time values based on new data samples collected over a defined time period; and
selecting a new adaptive threshold value from a quantile of the re-calculated set of quantiles.

11. The method of claim 8, wherein the first binary value is a 1 and the second binary value is a 0, or the first binary value is a 0 and the second binary value is a 1.

12. The method of claim 8, wherein the DNN comprises a set of multi-gate mixture-of-experts (MMoE) sub-networks to generate a set of metrics, wherein a MMoE sub-network of the set of MMoE subnetworks generates the long dwell metric.

13. The method of claim 12, wherein the long dwell metric is a continuous value.

14. The method of claim 13, comprising:
receiving the input vector by the MMoE sub-network;
generating the long dwell metric by the MMoE sub-network;
receiving a gating signal from a dwell time gate of a gating network of the DNN, the gating signal comprising a weight parameter for the MMoE sub-network; and
adding the long dwell metric to an output vector of the ML model.

15. The method of claim 13, comprising:
receiving an input vector from the set of features by a set of MMoE sub-networks;
generating a set of metrics by the set of MMoE sub-networks;
receiving a set of gating signals from a set of gates of a gating network of the DNN, wherein a gating signal comprises a weight parameter for a MMoE sub-network; and
adding the set of weighted metrics to an output vector of the ML model, wherein the set of metrics includes the long dwell metric.

16. The method of claim 15, wherein the set of metrics comprises passive metrics and active metrics.

17. The method of claim 16, wherein a passive metric comprises a click metric, a skip metric, a follow metric, or a save metric, and an active metric comprises a like metric, a share metric, a comment metric, the long dwell metric, a feedback metric, or a total contribution metric.

18. The method of claim 8, comprising:
adding the long dwell metric to a set of metrics in an output vector of the ML model;
sending the output vector to a second ML model; and
generating an engagement metric based on the set of metrics using a multi-objective optimization (MOO) function, wherein the engagement metric comprises a click-through-rate (CTR) value or a contribution value, the CTR value representing a probability that the entity ID will interact with the content item given the set of features, and the contribution value representing a measure of contribution of set of metrics to an objective of the second ML model.

19. A computing apparatus comprising:
circuitry; and
a memory storing instructions that, when executed by the circuitry, causes the circuitry to:
train a deep neural network (DNN) of a machine learning (ML) model over a set of training iterations, wherein a training iteration comprises:
retrieve a training sample from a training dataset, the training sample comprising a set of features and a target label, the set of features comprising video features associated with a video and entity features associated with an entity identifier (ID), the video features including a video length, and the target label comprising a value for a long dwell metric representing when a dwell time for the video is greater than or equal to an adaptive threshold value;
generate a predicted long dwell metric from the set of features using the DNN;
compute a loss value between the predicted long dwell metric and the long dwell metric using a loss function; and
adjust a set of model parameters for the DNN based on the loss value.

20. The computing apparatus of claim 19, wherein the value for the long dwell metric is a binary value or a continuous value.
